(19) United States
(12) Patent Application Publication
(10) Pub. No.: US 2016/0174474 A1
(43) Pub. Date: Jun. 23, 2016

(54) WOVEN GROUND COVER MATERIALS

(71) Applicant: Nine IP Limited, Auckland (NZ)

(72) Inventors: Jonathan Dallas TOYE, Albany (NZ); Suzanne Elizabeth FOY, Auckland (NZ)

(21) Appl. No.: 14/910,326

(22) PCT Filed: Aug. 8, 2014
(86) PCT No.: PCT/NZ2014/000166

§ 371 Date: Feb. 5, 2016

(30) Foreign Application Priority Data
Aug. 8, 2013 (NZ) 614071

(51) Int. Cl. A01G 13/00

(52) U.S. Cl. CPC A01G 13/0268

(57) ABSTRACT

A ground cover sheet material for use in agriculture is described. The sheet material has a greater length than width and is woven from at least two different types of tapes. The two different types of tapes have different reflecting, absorbing or transmission properties. Each type of tape forms at least 5% or 10% of the surface area of the ground cover material.

### FIELD OF THE INVENTION

The invention relates to woven ground cover materials.

### BACKGROUND TO THE INVENTION

Ground cover materials are used in agriculture for a number of purposes including weed suppression and/or soil warmth retention and/or moisture retention and/or for light reflecting.

Currently known important woven ground covers are as follows:
black pigmented plastic ground cover; green pigmented plastic ground cover;
and white pigmented plastic ground cover.

Black plastic ground covers typically warm the soil more than other pigmented ground covers.

Green plastic ground covers are used for aesthetics over other coloured pigmented ground covers.

Dark coloured pigmented plastic ground cover materials block light and are preferable for use in suppressing weeds. Black pigmented ground cover material is preferred for weed suppression.

Black pigmented ground covers are produced from plastic polymer pigmented with the carbon black pigment. White pigmented plastic ground covers look to increase reflected light into the plant canopy.

White pigmented ground covers are produced from plastic polymer pigmented with the white titanium dioxide pigment.

Typically where a material is used for weed suppression (herein referred to as weed matting) in an orchard or vineyard for example, the material is rolled out in lengths onto the ground beneath or between rows of trees or vines, or rows of berry fruit plants, and is secured in place.

In the application of weed suppression, dark or black coloured matting is preferred as dark or black matting is most effective at blocking sunlight reaching the ground beneath. However, in some locations or climates black matting may warm the soil excessively. Black weed mats warm the soil by absorbing light and converting it to heat that is then conducted to the soil by the contact between the mat and the soil.

Typically where a material is used primarily as a reflective ground cover for light enhancement, the material is again rolled out in lengths onto the ground, and secured in place, beneath or between rows of trees, vines, or plants, to increase the amount of light to which the plants are exposed by reflection of light from the material towards the fruit above. White matting may be used to reflect light towards the plants above, however, white matting is less effective for weed suppression since white matting is not as effective as black matting for blocking light reaching the soil and weeds beneath.

The sheet material will typically remain in place for some months, before being removed and reused in a subsequent growing season or on another crop in the same growing season, but in some cases may remain in place over multiple growing seasons. Or they may be used permanently in place until their useful life is finished.

It is an object of the present invention to provide improved ground cover materials, or to at least provide the public with a useful choice.

### SUMMARY OF THE INVENTION

In a first aspect, the present invention broadly consists in a ground cover sheet material having a greater length than width and woven from at least two different types of tapes, a first type of tape having different reflecting, absorbing or transmission properties to a second type of tape, each type of tape forming at least 5% or 10% of the surface area of the ground cover material.

In some embodiments the ground cover sheet material is woven from three different types of tapes, the ground cover comprising a third type of tape having different reflecting, absorbing or transmission properties to the first and second types of tapes, each type of tape forming at least 5% or 10% of the surface area of the ground cover material.

In some embodiments at least one of said types of tape reflect sufficient solar radiation in the visible (about 400-700 nm) range to enhance plant growth or fruit production of plants located proximate to said cover sheet material.

In some embodiments at least one of said types of tape impacts on reflectance, absorption or transmittance of solar radiation to enhance plant growth or fruit production of plants located proximate to said cover sheet material by Increasing soil temperature when compared to a black tape.

In some embodiments, where there are two types of tape, each type of tape may form at least 15%, 20%, 25%, 30%, 35%, 40% or 45% of the surface area of the ground cover material. In some embodiments, where there are three types of tape, each type of tape may form at least 15%, 20%, 25%, or 30% of the surface area of the ground cover material.

In some embodiments the ground cover material has a length greater than its width. In some embodiments the width is at least 0.5 m, 1.0 m, 1.5 m, 2.0 m, 2.5 m, 3.0 m, 3.5 m, 4.0 m, 4.5 m, 5 m, 6 m, 7 m, 8 m, 9 m, 10 m, 12 m, 14 m, 16 m, 18 m, 20 m, 25 m, or 30 m, and its length is at least 10, 20, 30, 40, 50, 75, 100, 125, 150, 175, 200, 250, 300, 400 or 600 times its width.

In some embodiments, the first type of tape comprises a first pigment system and the second type of tape comprises a second pigment system or is unpigmented.

In some embodiments the first pigment system comprises a first white pigment and the second pigment system comprises a second white pigment.

In some embodiments the first white pigment is a UV reflecting white pigment and the second white pigment is a UV absorbing white pigment.

In some embodiments the first pigment system comprises a first green pigment and the second pigment system comprises a second green pigment.

A pigment system may comprise one or more pigments.

In some embodiments the first pigment system comprises a pigment so that the first tape is coloured one of white, black, green, red, brown, tan and blue, and the second pigment system comprises a pigment so that the second tape is coloured a different one of white, black, green, red, brown, tan and blue

In some embodiments the first pigment system comprises a white pigment and the second pigment system comprises a black pigment, the ground cover material woven from black and white tapes.

In some embodiments the black pigment is an organic black pigment, for example carbon black.

The white pigment may be selected from the group consisting of zirconium dioxide, magnesium zirconate, calcium zirconate, strontium zirconate, barium zirconate, zirconium silicate, zinc sulphide, calcium carbonate, barium sulphate, magnesium oxide, strontium carbonate, barium carbonate, potassium tintanate, barium titanate, magnesium titanate, strontium titanate, neodymium titanate, tin oxide, titanium dioxide, titanium oxide, zinc oxide, zinc sulphide, zinc sulphate, dipotassium titanium trioxide, and potassium titanate, magnesium carbonate, aluminium oxide and aluminium hydroxide.

In some embodiments the white pigment is a UV reflecting white pigment. In some embodiments the white pigment is a UV absorbing white pigment, or the white pigment is a UV absorbing and high IR reflecting white pigment. In some embodiments the pigment is a white UV reflecting pigment, or a white UV reflecting pigment and a high IR reflecting white pigment. A high IR reflecting white pigment reflects over 40% of radiation across the wavelength range 700 to 2500 nm, or over 50% of radiation across the wavelength range 700 to 2500 nm.

In some embodiments other tape combinations may be useful. For example the first pigment system (in the first type of tape) may comprise a black pigment so that the first type of tape is black, and the second type of tape may comprise a clear pigment so that the second type of tape is clear. Or the first type of tape may be black and the second type of tape may be green, or a combination of black tapes and red tapes, or black tapes and brown tapes, or black tapes and blue tapes or white tapes and clear tapes, or white tapes and green tapes, or white tapes and red tapes, or white tapes and brown tapes, or white tapes and blue tapes or green tapes and clear tapes, or red tapes and clear tapes, or brown tapes and clear tapes, or brown tapes and blue tapes, or green tapes and red tapes, or green tapes and brown tapes, or green tapes and blue tapes, or red tapes and brown tapes or red tapes and blue tapes, or brown tapes and blue tapes.

In some embodiments the first type of tape comprises a first pigment system, the second type of tape comprises a second pigment system, and the third type of tape comprises a third pigment system. In some embodiments the first pigment system comprises a black pigment so that the first type of tape is black, the second pigment system comprises a white pigment so that the second type of tape is white, and the third pigment system comprises a clear pigment (or is unpigmented) so that the third type of tape is clear. In some embodiments other tape colour combinations may be useful. For example, the first tape may be black, the second tape white and the third tape green, or the three tapes may be black, white and red, or black, white and brown, or black, white, blue, or black, clear and green, or black, clear and red, or black, clear and brown, or black, clear, blue or black, green and red, or black, green and brown, or black, green, blue or black, red and brown, or black, red, blue, or black, brown, blue or white, clear and green, or white, clear and red, or white, clear and brown, or white, clear, blue, or white, green and red, or white, green and brown, or white, green, blue, or white, red and brown, or white, red, blue, or white, brown, blue, or clear, green, red, or clear, green, brown, or clear, green, blue, or clear, red, brown, or clear, red, blue, or clear, brown, blue, or green, red, brown, or green, red, blue, or green, brown, blue, or red, brown, blue.

In some embodiments the first tape comprising a white pigment reflects more solar radiation than it either transmits or absorbs in the UV (about 280-400 nm), visible (about 400-700 nm) and near infrared (about 700-800 nm) ranges, and which transmits at least part of radiation in the range about 800-2500 nm and at least part of radiation above about 2500 nm.

In some embodiments the reflectance and transmittance of the first tape is shown in the table below:

| Wavelength nm | Reflectance | Transmittance |
|---|---|---|
| 280-380 | 23-90% | 0-77% |
| 381-420 | 29-90% | 0-71% |
| 421-700 | 37-90% | 0-63% |
| 701-1000 | 29-89% | 0-71% |

In some embodiments the white pigment is chosen from zirconium, strontium, barium, magnesium and calcium pigments.

In some embodiments the white pigment is present in an amount of 5-50% by weight, or 5-30% by weight, or 5-25% by weight.

In some embodiments said white pigment is selected from the group consisting of zirconium dioxide, magnesium zirconate, calcium zirconate, strontium zirconate, barium zirconate, zirconium silicate, calcium carbonate, barium sulphate, magnesium oxide, strontium carbonate, barium carbonate, dipotassium titanium trioxide, and potassium titanate, magnesium carbonate, aluminium oxide and aluminium hydroxide.

In some embodiments said white pigment is selected from the group consisting of zirconium dioxide, barium sulphate and calcium carbonate.

In some embodiments said white pigment is calcium carbonate or barium sulphate.

In some embodiments the barium sulphate or calcium carbonate is provided in an amount of 12% to 30% by weight.

In some embodiments said barium sulphate or calcium carbonate is in the form of particles of size 0.5-3 microns.

In some embodiments said tapes comprise a polymer material with said pigments present in the polymer material, and the polymer-pigment mixture of said first type of tape is mono-oriented or biaxially-oriented.

In some embodiments said white pigment is a main pigment and the first type of tape comprises at least one co-pigment, the co-pigment or pigments comprising titanium dioxide or another UV absorbing substance in an amount that decreases the reflectance at 280 nm-400 nm due to the main pigment by increasing UV absorbance.

In some embodiments the first type of tape absorbs more solar radiation than it reflects in the UV (about 280-400 nm) range, and which reflects more solar radiation than it either transmits or absorbs in the visible (about 400-700 nm) and near infrared (about 700-800 nm) ranges, and which transmits at least part of solar radiation in the range about 800-2500 nm and at least part of solar radiation above about 2500 nm.

In some embodiments the reflectance and transmittance of the first type of tape is shown in the table below:

| Wavelength nm | Reflectance | Transmittance |
|---|---|---|
| 280-420 | 0 to 15% | 0 to 15% |
| 421-700 | 40-95% | 5-50% |

In some embodiments the first type of tape comprises an organic UV absorbing substance as a co-pigment.

In some embodiments the organic UV absorbing substance is added at a rate of 0.01% to 5% by weight.

In some embodiments the first tape comprises an inorganic clear or substantially clear UV absorbing pigment as a co-pigment.

In some embodiments the inorganic clear or substantially clear UV absorbing pigment is chosen from the group consisting of nano zinc oxide and cerium dioxide.

In some embodiments the inorganic clear UV absorbing pigment is added at a rate of 0.1% to 5% by weight.

In some embodiments first type of tape comprises an inorganic UV absorbing substance as a co-pigment.

In some embodiments the inorganic UV absorbing substance is added at a rate of 0.1% to 5% by weight.

In some embodiments the green is Pantone green 627U, or has CIELAB coordinates L*, a*, b* of about 32, −6.6 and 4.1.

In some embodiments the tan is Pantone tan 7502U or has CIELAB coordinates L*, a*, b* of about 66, 6.6 and 18.3.

In some embodiments the grey is Pantone grey 426U.

In some embodiments the grey is a colour with CIELAB coordinates L*, a*, b* of about 49, 0.2 and 3.3.

In some embodiments the grey is a colour with CIELAB coordinates L*, a*, b* of about 40, −0.5 and −3.4.

In some embodiments one of the types of tapes of the ground sheet material is coloured green. In some embodiments, the green type of tape comprises:
a polymer and a green pigment derived from one or more pigments mixed to form a polymer-pigment mixture with solar radiation reflecting and absorbing or transmittance properties, and
at least one additional pigment added to the polymer-pigment mixture which does not significantly decrease the amount of solar radiation transmitted by the polymer-pigment mixture of the material in the range of about 700 nm-2500 nm, and/or
at least one additional pigment added to the polymer-pigment mixture which decreases the amount of solar radiation transmitted by the material in the blue light range of about 440 nm-490 nm and in the red light range of about 620 nm-700 nm.

The term “does not significantly decrease” as used herein with reference to an amount of solar radiation transmitted means that the amount of solar radiation transmitted is not decreased by more than 2%, 3%, 4%, 5%, 6%, 7%, 8%, 9%, 10%, 15%, 20%, 25% or 30%.

In some embodiments one of the types of tapes of the ground sheet material is coloured green. In some embodiments, the green type of tape comprises:
a polymer and a green pigment (derived from either one or more pigments) mixed to form a polymer-pigment mixture with solar radiation reflecting and absorbing or transmittance properties, and
at least one additional pigment added to the polymer-pigment mixture to increase the amount of solar radiation transmitted by the polymer-pigment mixture in the range of about 700 nm-2500 nm.

The following statements may relate to either of the above described green tapes.

In some embodiments the at least one additional pigment added to the polymer-pigment mixture increases the amount of solar radiation transmitted by the polymer-pigment mixture in the range of about 700 nm-2500 nm.

In some embodiments the material comprises at least one additional pigment added to the polymer-pigment mixture which does not significantly decrease the amount of solar radiation transmitted by the material in the range of about 700 nm-2500 nm, and
at least one additional pigment added to the polymer-pigment mixture which decreases the amount of solar radiation transmitted by the material in the blue light range of about 440 nm-490 nm and in the red light range of about 620-700 nm.

In some embodiments the material comprises at least one additional pigment added to the polymer-pigment mixture which does not significantly decrease the amount of solar radiation transmitted by the material in the range of about 700 nm-2500 nm and/or which decreases the amount of solar radiation transmitted by the material in the blue light range of about 440 nm-490 nm and in the red light range of about 620-700 nm.

In some embodiments the at least one additional pigment increases, or at least does not decrease, the amount of solar radiation transmitted by the material in the range of about 700 nm-760 nm or 700 nm-800 nm.

In some embodiments the at least one additional pigment increases the absorption of blue light and/or red light in the material.

In some embodiments the material transmits more solar radiation than it reflects in the range of about 700 nm-2500 nm.

In some embodiments the material is substantially transparent to solar radiation in the range of about 700 nm-2500 nm.

In some embodiments the material at least partly absorbs solar radiation in the UV (about 280-400 nm) range and the visible (about 400-700 nm) range. In some embodiments the material absorbs at least 10%, 20%, 30%, 40%, 50%, 60%, 70%, 80%, 90% or 95% of solar radiation in the UV (about 280-400 nm) range. In some embodiments the material absorbs at least 10%, 20%, 30%, 40%, 50%, 60%, 70%, 80%, 90% or 95% of solar radiation in the visible (about 400-700 nm) range.

In some embodiments the green pigment is phthalocyanine green. In some embodiments the phthalocyanine green is provided in the amount of 0.5-5%, or 0.5-4%, or 0.5-3%, or 0.5-2%, or 0.5-1% by weight.

In some embodiments the material comprises iron oxide as an additional pigment. In some embodiments the iron oxide is provided in the amount of 0.2-5%, or 0.2-4%, or 0.2-3%, or 0.2-2%, or 0.2-1%, or 0.2-0.75% by weight.

In some embodiments, the iron oxide is iron oxide red. In some embodiments, the iron oxide is red Fe₂O₃ (Fe III). In some embodiments, the iron oxide is red heamatite Fe₂O₃ (Fe III). In some embodiments, the iron oxide is micronized.

In some embodiments the material comprises organic orange as an additional pigment. In some embodiments the organic orange is benzimidazolone. In some embodiments the organic orange is provided in the amount of 0.2-5%, or 0.2-4%, or 0.2-3%, or 0.2-2%, or 0.2-1%, or 0.2-0.4% by weight.

In some embodiments the material comprises silica as an additional pigment. In some embodiments the silica is provided in the amount of 0.2-5%, or 0.2-4%, or 0.2-3%, or 0.2-2%, or 0.2-1%, or 0.2-0.4% by weight.

In some embodiments the green tapes are substantially transparent to solar radiation above about 700 nm. In some embodiments, the ground cover material is at least 55%, 60%, 65%, 70%, 75%, 80%, 85%, 90% or 95% transparent to solar radiation in the range about 700 nm to 2000 nm.

In some embodiments the green tapes are more than 10%, 20%, 30% or 40% transparent to solar radiation across the wavelength range of 650 to 800 nm or 700-760 nm.

In some embodiments one of the types of tapes of the ground sheet material is coloured green. In some embodiments, the green type of tape comprises:
a polymer and a green pigment mixed to form a polymer-pigment mixture with solar radiation reflecting and absorbing or transmittance properties, and
at least one co-pigment added to the polymer-pigment mixture to increase the amount of solar radiation transmitted by the polymer-pigment mixture in the range of about 700 nm-2500 nm.

In some embodiments one of the types of tapes of the ground sheet material is coloured green. In some embodiments, the green type of tape is substantially transparent to solar radiation above about 700 nm and absorbs some solar radiation in the UV (about 280-400 nm) range and the visible (about 400-700 nm) range.

In some embodiments the green tapes have more than 10% transparency to solar radiation across the wavelength range of 700 to 800 nm and absorbs more blue light (440 to 490 nm) than green light (490 to 570 nm), and absorbs more red light (620 to 780 nm) than green light (490 nm to 570 nm).

In some embodiments the green tapes have average transmission across the wavelength range 900-1000 nm of at least 55, 58, 60, 62, 65 or 67 percentage points greater than the average wavelength across the 500-600 nm range.

In some embodiments the green tapes transmits more than either 15%, 20%, 25%, 30%, 35%, 40%, 45%, 50%, 60%, 70%, 80%, 90%, or 95% of solar radiation across the wavelength range 700-800 nm, or across the wavelength range 700 to 760 nm.

In some embodiments the green tapes transmits more than 30%, 40%, 50%, 60%, 70%, 80%, 90%, or 95% of solar radiation across the wavelength range 700 to 2100 nm.

In some embodiments the green tapes absorbs more than either 20%, 30%, 40%, 50%, 60%, 70%, 80%, 90%, or 95% of the total of blue light plus red light and transmits more than either 20%, 30%, 40%, 50%, 60%, 70%, 80%, 90%, or 95% of green light.

In some embodiments the green tapes reflects at least 10%, 20%, 30%, 40%, 50%, 60% or 70% of green light.

In some embodiments the green tapes absorbs more than at least 10%, 20%, 30%, 40%, 50%, 60%, 70%, 80%, 90% or 95% of solar radiation in the UV range of about 280-400 nm.

In some embodiments the green tapes transmits less than either 90%, 80%, 70%, 60%, 50%, 40%, 30%, 20% or 10% of solar radiation in the UV range of about 280-400 nm.

In some embodiments the green tape material is colour stable for a period of at least 1.0, 1.5, 2.0, 2.5, 3, 4, 5, 6, 7, 8, 9, 10, 11 or 12 years. “Colour stable” as used herein means that the colour of the material has a light fastness of at least 7, preferably 8, on the blue wool scale. The blue wool scale is a measure of colour permanence, on a scale of 0 to 8. Colours with little permanence have a low value on the scale (e.g. 1 or 2), whereas colours with a high degree of permanence are rated at the high end of the scale (e.g. 7 or 8).

In some embodiments the green colour of the green tapes has CIELAB colour space coordinates of L*=32.1, a*=−6.64, and b*=4.13 or coordinates having a delta-E value of less than 24 of those readings. In some embodiments, the delta-E value is less than 6, 12, 18 or 24 of these coordinates.

In some embodiments the green type of tape comprises less than 0.5% or 0.3%, 0.1% or 0.05% by weight carbon black pigment, or contains no carbon black pigment.

In some embodiments one of the types of tapes of the ground sheet material is coloured green. In some embodiments, the green type of tape comprises:
a polymer or polymers and pigments together forming a polymer-pigment mixture, wherein the pigments comprise phthalocyanine green, iron oxide and organic orange (benzimidazolone).

In some embodiment the first type of tape is one of green and white and the second type of tape is the other one of green and white. In some embodiment the first type of tape is one of black and white and the second type of tape is the other one of black and white.

In a further aspect the present invention provides a ground cover sheet for use in horticulture comprising a ground cover material of the present invention.

Typically sheets of the invention will be laid out in lengths on the ground between or beneath rows of the crop being grown, which may be trees, vines, bushes etc. It is possible however that the covers may be suspended or positioned above the ground in a vertical or angled position to effect the solar radiation onto the crop, for example on either side of the crop row, for example trees.

Transmission, absorbance and reflectance values as discussed herein are with reference to the individual tapes present in the ground cover sheet, rather than the ground cover sheet as a whole, unless otherwise stated.

The term “blue light” as used in this specification and claims means solar radiation across the wavelength range 440 to 490 nm.

The term “red light” as used in this specification and claims means solar radiation across the wavelength range 620 to 780 nm. The term as used herein therefore includes some wavelengths in the near infrared range, and more particularly includes near infrared that is in the photosynthetic active response range.

The term “green light” as used in this specification and claims means solar radiation across the wavelength range 490 to 570 nm.

The term “substantially transparent” as used in this specification and claims means having a transparency of at least 50%.

A colour may be defined by the International Commission on Illumination (French Commission Internationale de l'éclairage) colour space coordinates L*, a* and b* (CIELAB). In the CIELAB 3-dimensional colour space, one dimension L* is lightness, one dimension a* is colour extending from green (−a) to red (+a), and one dimension b* is colour extending from blue (−b) to yellow (+b). The rectangular colour coordinates a* and b* may be converted to polar form to be represented by hue)(h° being the angular component and chroma (C*) being the radial component. Colours of materials according to embodiments of the present invention may be defined by L*, and the rectangular coordinates a* and b* and/or the polar coordinates h° and C*.

A range of colours may be defined by a Delta-E metric that provides a measure of the difference between two colours, for example, the International Commission on Illumination CIE DE2000 Delta-E value. Unless otherwise specified, in this specification and claims, Delta-E is the CIE DE2000 value.

The L*, a* and b* measurements as used herein are defined with reference to an injection moulded chip of size 40 mm long by 50 mm wide and 1.1 mm thick, having a gloss finish. The injection moulded chips were moulded in high density polyethylene HHI302. The machine used to take the readings was a Datacolor SF600+CT spectrometer using a D65 light source for daylight conditions at 10% angle. The measurements are inclusive of gloss.

In some embodiments the first type of tape comprises a first pigment system, the second type of tape comprises a second pigment system and the third type of tape comprises a third pigment system or is unpigmented.

In some embodiments
the first pigment system comprises a pigment so that the first tape is coloured one of white, black, green, red, brown, aluminium or blue, and
the second pigment system comprises a pigment so that the second tape is coloured a different one of white, black, green, red, brown and blue to the colour of the first tape, and
   the third pigment system comprises a pigment so that the third tape is coloured a different one of white, black, green, red, brown and blue to the colours of the first and second tapes.

In some embodiments the first type of tape is white comprising a white pigment, the second type of tape is black comprising a black pigment, and the third type of tape is green comprising a green pigment.

In some embodiments the sheet material the first type of tape is black comprising a black pigment, the second type of tape is green comprising a green pigment, and the third type of tape comprises an metallic pigment, for example an aluminium pigment.

In some embodiments the first type of tape is a first colour, the second type of tape is a second colour, and the third type of tape is a third colour.

In some embodiments the first colour is green and the second colour is brown.

In some embodiments the first colour is green and the second colour is tan.

In some embodiments the first colour is Pantone green 627U and the second colour is Pantone tan 7502U.

In some embodiments the green has CIELAB coordinates L*, a*, b* of about 32, −6.6 and 4.1, and the tan has CIELAB coordinates L*, a*, b* of about 66, 6.6 and 18.3.

In some embodiments the third colour has CIELAB colour space coordinates L*, a*, b* of about 50, −1.5 and 16.8.

In some embodiments tapes of the third colour comprise a blend of 10 to 30% of a masterbatch of the first colour and 70 to 90% of a masterbatch of the second colour.

In some embodiments tapes of the third colour comprise a blend of 20% of a masterbatch of the first colour and 80% of a masterbatch of the second colour.

In some embodiments the first colour is green and the second colour is grey.

In some embodiments the first colour is Pantone green 627U and the second colour is Pantone grey 426U.

In some embodiments the green is a colour with CIELAB colour space coordinates L*, a*, b* of about 32, −6.6 and 4.1, and the grey a colour with CIELAB colour space coordinates L*, a*, b* of about 49, 0.2, 3.3.

In some embodiments the third colour with CIELAB colour space coordinates L*, a*, b* of about 41, −2 and 3.7.

In some embodiments the first colour is Pantone green 627U and the second colour is a colour with CIELAB coordinates L*, a*, b* of about 49, 0.2 and 3.3.

In some embodiments the tapes of the third colour comprise a blend of 10 to 30% of a masterbatch of the first colour and 70 to 90% of a masterbatch of the second colour.

In some embodiments the third colour is a blend of 80% of the first colour and 20% of the second colour.

In some embodiments the first colour is tan and the second colour is grey.

In some embodiments the first colour is Pantone tan 7502U and the second colour is a colour with CIELAB coordinates L*, a*, b* of about 49, 0.2 and 3.3.

In some embodiments the tan is a colour with CIELAB colour space coordinates L*, a*, b* of about 66, 6.2 and 18.3 and the grey is a colour with CIELAB colour space coordinates L.*, a*, b* of about 49, 0.2, 3.3.

In some embodiments the third colour is a colour with CIELAB colour space coordinates L*, a*, b* of about 55, 3 and 12.

In some embodiments the first colour is colour is Pantone tan 7502U and the second colour is a colour with CIELAB coordinates L*, a*, b* of about 40, −0.5 and −3.4.

In some embodiments the tan is a colour with CIELAB colour space coordinates L*, a*, b* of about 66, 6.2 and 18.3 and the grey is a colour with CIELAB colour space coordinates L*, a*, b* of about 40, −0.5 and −3.4.

In some embodiments the third colour is a colour with CIELAB colour space coordinates L*, a*, b* of about 49, 0.2 and 3.3.

In some embodiments the third colour is a blend of 70 to 90% of the first colour and 10 to 20% of the second colour.

In some embodiments the third colour is a blend of 80% of the first colour and 20% of the second colour.

In some embodiments the first type of tape comprises a pigment at a first pigment level and the second type of tape comprises the pigment at a second pigment level.

In some embodiments the pigment is a black pigment and the first pigment level is 1.5% to 2.5% by weight and the second pigment level is 0.5% to 1.5% by weight.

In some embodiments the pigment is a white pigment and the first pigment level is 1% to 5% by weight and the second pigment level is 0.1% to 1.0% by weight.

In some embodiments the pigment is a UV reflecting white pigment and the first pigmentation level is 15% to 30% by weight and the second pigmentation level is 5% to 15% by weight.

In some embodiments the first type of tape comprises a first thickness and the second type of tape comprises a second thickness, the first thickness being greater than the second thickness.

In some embodiments the first thickness is at least 20% more than the second thickness.

In some embodiments the first thickness is at least 50% more than the second thickness.

In some embodiments the first thickness is at least 1.2 to 5 times the second thickness.

In some embodiments the thickest tapes comprise multiple individual tapes stacked together.

In one embodiment, the first type of tape comprises a white pigment and the first thickness, and the second type of tape comprises a black pigment and the second thickness, and the first thickness is greater than the second thickness.

In some embodiments the ground cover sheet material comprises warp and weft tapes, and some of the warp tapes are formed from one of the first type of tape and the second type of tape, and other warp tapes are formed from the other one of the first type of tape and the second type of tape.

In some embodiments the ground cover sheet material comprises warp and weft tapes, and at least some of the warp tapes are formed from one of the first type of tape and the second type of tape, and at least some of the weft tapes are formed from the other one of the first type of tape and the second type of tape.

In some embodiments at least some of the warp tapes are formed from one of the first type of tape and the second type of tape and substantially all of the weft tapes are formed from the other one of the first type of tape and the second type of tape.

In some embodiments substantially all of the warp tapes are formed from one of the first type of tape and the second type of tape and at least some of the weft tapes are formed from the other one of the first type of tape and the second type of tape.

In some embodiments substantially all of the warp tapes are formed from one of the first type of tape and the second type of tape and substantially all of the weft tapes are formed from the other one of the first type of tape and the second type of tape.

In some embodiments a majority of the warp tapes comprise one of the first type of tape and the second type of tape, and a majority of the weft tapes comprise the other one of the first type of tape and the second type of tape.

In some embodiments the warp tapes in a portion of the width of the sheet material are formed from one of the first type of tape and the second type of tape and the warp tapes in a remaining portion of the width of the cover material comprise the other one of the first type of tape and the second type of tape.

In some embodiments the portion is a central portion of the width of the sheet material.

In some embodiments the portion is a side portion adjacent a longitudinal side of the ground cover sheet material.

In some embodiments the portion comprises at least 10% or 20% or 30% or 40% or 50% or 60% or 70% or 80% of the width of the ground cover sheet material.

In some embodiments alternate warp tapes are formed from the first and second types of tape.

In some embodiments the warp tapes are formed into groups of warp tapes formed from the first type of tape and spaced apart across the width of the ground cover sheet material by groups of warp tapes formed from the second type of tape.

In some embodiments each group of warp tapes formed from the first type of tape cover at least 10% of the width of the ground cover sheet material and each group of warp tapes formed from the second type of tape cover at least 10% of the width of the ground cover sheet material.

In some embodiments the sheet material comprises a third type of tape, wherein some warp tapes are formed from the third type of tape.

In some embodiments the sheet material comprises alternate warp tapes in a portion of the width of the material are formed from the first and second types of tape, and warp tapes in a remaining portion of the width of the material comprise the third type of tape.

In some embodiments the sheet material comprises the portion is a longitudinal central portion of the ground cover sheet material, the remaining width of the cover material being side portions of the cover material.

In some embodiments the sheet material comprises the portion is a longitudinal side portion or longitudinal side portions located on either side of a central longitudinal portion, the central portion being the remaining width of the material.

In some embodiments in sheet material substantially all of the weft tapes comprise one of the first type of tape, the second type of tape and the third type of tape.

In some embodiments the sheet material comprises a third type of tape, wherein some weft tapes are formed from the third type of tape.

In preferred embodiments the warp tapes and the weft tapes have a rectangular cross-section.

The tapes may be formed from any suitable polyolefin such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA) and ethylene methyl acrylate (EMA) are useful for imparting elasticity and other properties. Polyesters and polystyrene, styrene-butadiene (SB), acrylonitrile-butadiene-styrene (ABS), styrene-acrylonitrile (SAN), polyethylene terephthalate (PET), polymethylmethacrylate (PMMA) and polycarbonate. Starch and other plant polymers are useful to increase biodegradability.

Alternatively the tapes may comprise in part or whole of paper, wood or cellulose fibre, starch based polymers, casein, latex or in any combination of the above and/or with petroleum derived plastic polymers. The polymer or polymer blend may incorporate agents such as one or more pigments, UV stabilisers, or processing aids.

Typically sheet materials of the invention will be laid out in lengths on the ground between or beneath rows of the crop being grown, which may be trees, vines, bushes etc, and the materials are referred to in the specification as “ground cover sheet materials”. It is possible however that the materials may be suspended or positioned above the ground in a vertical or angled position to reflect the solar radiation onto the crop, for example on either side of the crop row, for example trees, and the expression “ground cover sheet material” is intended to encompass materials for such applications also.

The following is a description of the spectrophotometer system and measuring method used for measuring solar radiation reflectance and transmittance values quoted in this specification unless otherwise stated.

The spectrophotometer system is based around a GSA/McPherson 2051 1 metre focal length monochromator fitted with a prism predisperser and also stray light filters. The light source is a current regulated tungsten halogen lamp. The bandwidth is adjustable up to 3 nm. The monochromatic beam from the monochromator is focused onto the sample or into the integrating sphere using off-axis parabolic mirrors. The integrating spheres are coated with pressed halon powder (PTFE powder). Halon powder is also used as a white reflectance reference material. The detector is usually a silicon photodiode connected to an electrometer amplifier and digital volt meter. The whole system is controlled using software written in LabVIEW. The detectors used can be photomultiplier tubes, silicon diodes or lead sulphide detectors.

Diffuse Reflectance Sphere

Diffuse reflectance is measured using an integrating sphere with an internal diameter of 75 mm and sample tilted at an angle of 6° to the incident light (specular reflectance included). The reference sample is pressed halon powder and a black cone is used to correct for stray light. Up to four test samples are mounted on a pneumatic driven sample changer along with the white reference and black cone.

Diffuse Transmittance Sphere

Diffuse transmittance is measured using an integrating sphere with an internal diameter of 120 mm and coated with pressed halon powder. The sample is mounted on one port and the incident light port is at an angle of 90° around the sphere. The sphere rotates by 90° in the horizontal plane to allow the focused incident light to enter the sphere through the incident light port or the incident light to be transmitted through the sample and enter the sphere. The detector is mounted at the top of the sphere.

The term “enhance plant growth or fruit development” as used in this specification includes increasing the rate of plant growth, increasing the amount of vegetative growth, controlling the amount of vegetative growth and enhancing bud set, fruit colour development, fruit brix or flavour characteristics, and fruit size.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Preferred embodiments of the invention will be further described by way of example only and with reference to the accompanying drawings, in which:

FIG. 1 is a schematic stylised plan view of a section of ground cover material of the invention, woven with warp and weft tapes;

FIG. 2A is an elevation view of woven ground cover materials of the invention fixed to the ground between rows of trees or crops growing on mounded soil;

FIG. 2B is an elevation view of woven ground cover materials of the invention fixed to the ground between rows of trees or crops growing on flat soil;

FIG. 2C is an elevation view of woven ground cover materials of the invention fixed to the ground between rows of trees or crops growing on sloping soil;

FIG. 3 is a schematic perspective view showing the typical defining dimensions of rectangular cross-section warp or weft tapes used to weave the ground cover materials of the invention;

FIG. 4 is a close up cross-section view of one embodiment of a ground cover sheet material of the invention in which there is a thickness difference between some of the warp tapes and other warp tapes;

FIG. 5 is a view from perpendicular to the plane thereof of a flat length of material of one embodiment;

FIG. 6 is a view from perpendicular to the plane thereof of a flat length of material of another embodiment;

FIG. 7 is a view from perpendicular to the plane thereof of a flat length of material of yet another embodiment.

FIG. 8 is a view from perpendicular to the plane thereof of a flat length of material of yet another embodiment.

FIG. 9 is a view from perpendicular to the plane thereof of a flat length of material of yet another embodiment.

FIG. 10 is a view from perpendicular to the plane thereof of a flat length of material of yet another embodiment.

FIG. 11 is a graph of average daily soil temperatures, obtained from a field trial in Washington State USA, for three different types of ground cover materials, a black ground cover material, an ultra violet (UV) reflecting white ground cover material, and a black and white composite ground cover material.

FIG. 12 is a graph of average daily soil temperature, obtained from a further field trial in Washington State USA, of three different types of ground cover materials, a, and third material being a composite of the previous two.

FIG. 13 is a graph illustrating the effect of a ground cover material of the invention on mean daily soil temperature;

FIG. 14 is a graph comparing diffuse transmittance of a prior art green material to a prior art black material;

FIG. 15 is a graph comparing diffuse transmittance of a prior art green material to a material of the invention;

FIG. 16 is a graph comparing diffuse transmittance of a prior art “artificial grass” coloured green material to a material of the invention;

FIG. 17 is a graph comparing diffuse transmittance of a prior art white ground cover material to a material of the invention;

FIG. 18 is a graph illustrating diffuse transmittance of a green ground cover material of the invention compared to a prior art black ground cover material and a prior art white ground cover material;

FIG. 19 is a table of the data from which the graph of FIG. 9 was produced;

FIG. 20 is a table illustrating diffuse absorbance of a green ground cover material of the invention compared to a prior art black ground cover material and a prior art white ground cover material; and

FIG. 21 is a table illustrating diffuse reflectance of a green ground cover material of the invention compared to a prior art black ground cover material and a prior art white ground cover material.

### DETAILED DESCRIPTION OF PREFERRED EMBODIMENTS

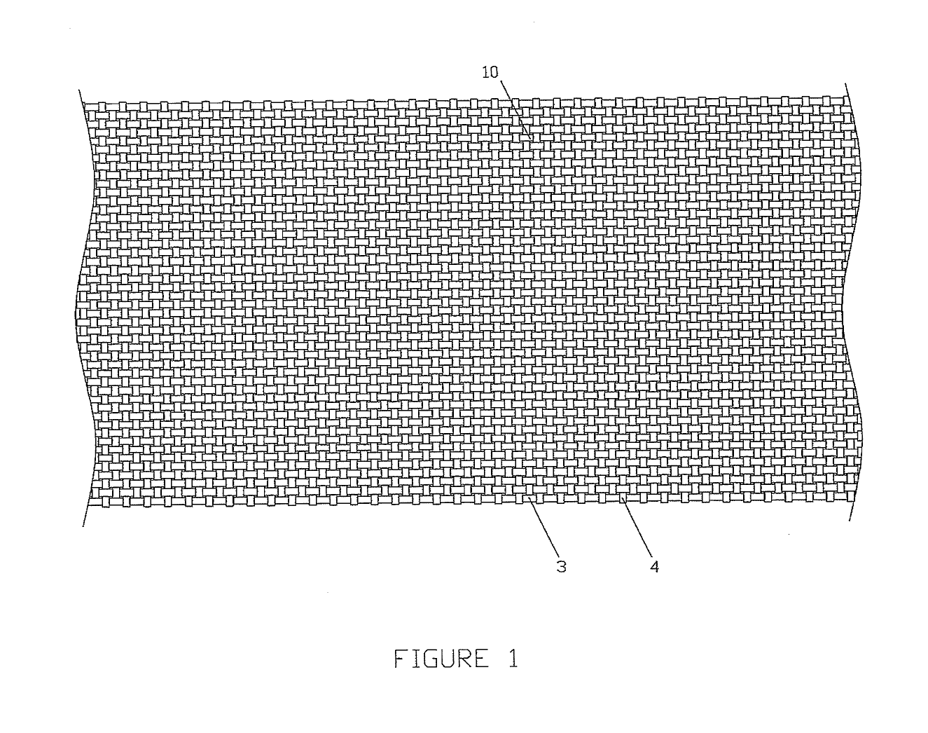

FIG. 1 shows a section of ground cover material or sheeting 10. The material 10 is woven from flat warp 3 and weft 4 tapes of a plastics material. Preferably the sheeting does not have gaps, holes, slits or openings greater than 1.5 mm in or between the tapes so as to minimise unwanted plant growth through the sheets of material. Normally there would be tape cramming (tape folding) between the tapes, to close out any gaps; this is not shown in the figure. The tapes may be formed by extruding a film material from a polymer resin and then cutting the film into tapes which are in turn used to weave the material, or by extruding individual tapes. The tapes may be formed from a polymer containing pigments which give the ground cover material desired properties, such as desired light reflective, absorptive and/or transmission properties for example.

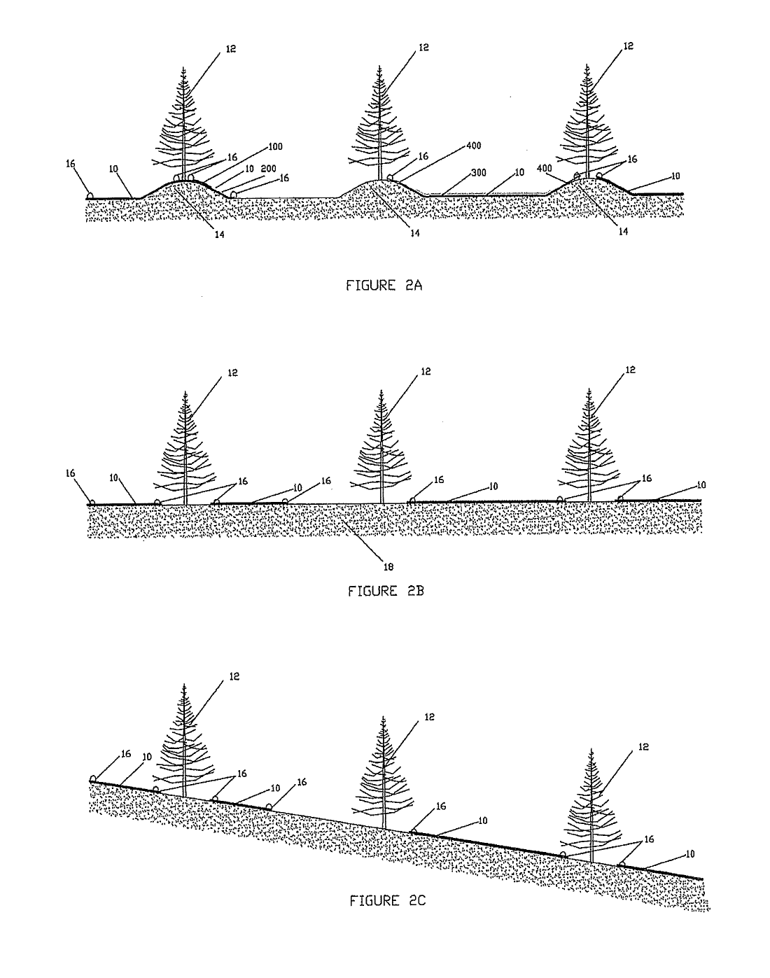

Typically the material has a greater length than width and is provided as a roll or in concertina folded form. Referring to FIGS. 2a-2c, lengths of the ground cover material 10 can be fixed between or beneath rows of crops, for example fruit trees 12, in various ways depending on the primary function of the ground cover material, for example weed suppression or soil warming. FIG. 2a shows lengths of ground cover material 10 laid on the ground underneath a tree (left) and between rows of orchard trees 12 (right). The material is preferably staked or stapled to the ground by staples or pegs hammered or pushed through the material and into the ground. The orchard trees 12 in this form are grown on rows of mounded soil 14, and the lengths of material 10 are fixed peripherally along each side into the ground by stakes or pegs 16. FIG. 2b shows a similar fixing configuration for lengths of ground cover material laid on flat ground soil 18, and FIG. 2c shows use of the ground cover material on a sloped ground surface 20. It will be appreciated that the ground cover materials may be employed on any type of profile of ground surface, whether flat, mounded, sloped, undulating, contoured or a combination of these.

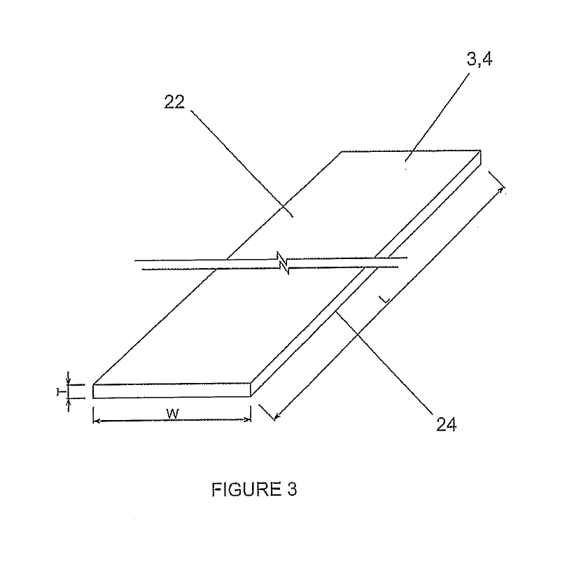

FIG. 3 shows dimensional profile and shape of substantially rectangular cross-section warp and/or weft tapes which may be used to weave the ground cover material, for the purpose of further explanation of the various embodiments of the ground cover material. The warp and/or weft tapes 3 and 4, have an indefinite length, designated by reference double-ended arrow L. The top and bottom surfaces 22 and 24 of the tape form the top and bottom surfaces of the ground cover material once woven. In this form the tapes are substantially rectangular in cross-section and have a width, designated by double-ended arrow W, and a thickness, designated by double-ended arrow T. It will be appreciated that the width and thickness of the tapes are substantially uniform along the length of the tape. In other forms the tapes may have different cross-section shapes, for example oval, round or square.

As described above, a ground sheet material is prepared from tapes that are woven together. In a ground sheet according to the present invention, different tapes in the ground sheet material are made from materials comprising different pigments/dyes or of different thicknesses to impart various combinations on the resulting sheets' reflectance, transmittance and absorption properties.

A ground sheet according to the present invention is wound from two or more different types of tapes. The different types of tapes have different reflectance, transmittance and absorption properties.

Separate tapes having different reflectance, transmittance and absorption characteristics in a sheet of ground cover material is a useful design feature in that it allows separation of different characteristics that if mixed together produce a less desirable effect. For example, a ground sheet material woven from tapes where the component mixture making up each tape comprises a mixture of both dark and white pigments achieves less than ideal properties for both weed suppression and reflection. Separation of different characteristics into individual tapes produces a ground cover sheet material that has more superior features for some crops than if mixed together or provided singularly. The use of separate tapes having different reflectance, transmittance and absorption characteristics may also have very large manufacturing advantages. More specifically, prior to the present invention, when a ground cover sheet with specified reflectance, transmittance and absorption characteristics was required, a pigment-polymer master batch would be prepared and then tapes extruded from a master batch specifically made to produce the desired characteristics. The present invention enables ground cover sheets having a range of reflectance, transmittance and absorption characteristics to be prepared from a small number (e.g. 2 or 3) of types of already prepared and extruded tapes. This may enable significant benefits in terms of reducing the time it takes to fulfil an order for a product because stock tapes can be used rather than requiring extrusion of tapes for the specific product, and in terms of cost and waste associated with preparing and extruding separate master batch mixes for each product.

In one embodiment of the present invention, a ground cover sheet material is formed by weaving together tapes comprising a dark coloured pigmentation and separate tapes comprising a white coloured pigmentation.

In one embodiment the white coloured pigment is a white UV reflective pigment. Alternatively the white pigment is a UV absorbing white pigment or a UV absorbing and high infra red (IR) reflecting white pigment.

In a preferred embodiment, the ground cover sheet material is woven from tapes comprising a black pigment, for example an organic black pigment such as carbon black, and separate tapes comprising white pigmentation, so that the sheet material comprises a combination of black and white tapes woven together.

In some embodiments the white pigment is selected from the group consisting of zirconium dioxide, magnesium zirconate, calcium zirconate, strontium zirconate, barium zirconate, zirconium silicate, calcium carbonate, barium sulphate, magnesium oxide, strontium carbonate, barium carbonate, dipotassium titanium trioxide, and potassium titanate, magnesium carbonate, aluminium oxide and aluminium hydroxide.

In some embodiments white tapes comprises a white pigment which reflects more solar radiation than it either transmits or absorbs in the UV (about 280-400 nm), visible (about 400-700 nm) and near infrared (about 700-800 nm) ranges, and which transmits at least part of radiation in the range about 800-2500 nm and at least part of radiation above about 2500 nm. In some embodiments, the white tape comprises the reflectance and transmittance properties shown in the table below:

| Wavelength nm | Reflectance | Transmittance |
|---|---|---|
| 280-380 | 23-90% | 0-77% |
| 381-420 | 29-90% | 0-71% |
| 421-700 | 37-90% | 0-63% |
| 701-1000 | 29-89% | 0-71% |
| 1001-1640 | 30-90% | 9-70% |
| 1641-2200 | 18-93% | 7-82% |

Preferred white pigments are zirconium, strontium, barium, magnesium and calcium pigments, added in amounts of 5-50% by weight, or 5-30% by weight, or 5-25% by weight.

In some embodiments there is provided a mono-orientated or biaxially orientated reflective material comprising a polymer or polymers and at least one substantially white pigment, that when mixed with the polymer(s) to form a polymer/pigment mix, that when extruded and mono-orientated and/or biaxially-orientated provides increased reflectivity relative to the same material without mono-orientation or biaxial-orientation of the polymer and pigment(s) mixture.

The production of polyolefin polymers based on what has been termed single site catalyst, or metallocene catalysts allow control over polymer architecture and are preferred polyolefins for orientation purposes.

A reflective plant treatment material comprising polymer(s) and at least one substantially white pigment that when mixed with the polymer(s) to form a polymer/pigment mixture, that when extruded and mono-orientated or biaxially-orientated provides increased reflectivity relative to the same material without mono-orientation or biaxial-orientation of the polymer(s) and pigment(s) mixture may be manufactured by treating a thick and wide plastic tape containing a pigment in a form allowing mono-orientation by stretching the tape to decrease its thickness and width and orientate the polymer(s) and pigment(s) mixture.

The development of this enhanced reflectivity of the polymer(s) and pigment(s) mixture is not limited to tapes. It can be also achieved by the mono-orientation of cast extruded film as a sheet. Additionally it can be also developed in blown film which is biaxially orientated and can also have greater orientation in one of the two orientation directions. This blown film can later be further orientated either mono-orientated or biaxially orientated.

A reflective plant treatment material may be manufactured by a method comprising the placement of aluminium or other metallic pigment into polymer(s) with subsequent orientation by methods analogous to those described above for polymers comprising substantially white pigments. Maximisation of the reflectivity of metallic pigments with minimal “greying” or absorption of visible light is achieved using grades of aluminium pigments with high reflectivity of visible.

In some embodiments, a white tape woven in the sheet material absorbs more solar radiation than it reflects in the UV (about 280-400 nm) range, and which reflects more solar radiation than it either transmits or absorbs in the visible (about 400-700 nm) and near infrared (about 700-800 nm) ranges, and which transmits at least part of solar radiation in the range about 800-2500 nm and at least part of solar radiation above about 2500 nm. Such a sheet material may provide reflection of solar radiation, in particular 400 to 700 nm, visible light, to increase the amount of light to which plants and fruit are exposed, but without increasing the amount of UV on the fruit or plants, which can be damaging to the plant and fruits. Also, UV absorption improves the longevity of the material by reducing the effects of degrading UV light on plastic polymers of the material.

In some embodiments, the white tape (for example the first type of tape) absorbs more solar radiation than it reflects in the UV (about 280-400 nm) range, and reflects more solar radiation than it either transmits or absorbs in the visible (about 400-700 nm) and near infrared (about 700-800 nm) ranges; and the tape material reflects at least about 50% of solar radiation in the infrared range of about 700-1000 nm, and/or reflects at least about 40% of solar radiation in the infrared range of about 1000-1500 nm, and/or reflects at least about 30% of solar radiation in the infrared range of about 1500-2000 nm.

In some embodiments, the tape material reflects at least about 50% of solar radiation in the infrared range of about 700-1000 nm, and/or reflects at least about 40% of solar radiation in the infrared range of about 1000-1500 nm, and/or reflects at least about 30% of solar radiation in the infrared range of about 1500-2000 nm.

In some embodiments a white tape in the ground cover material has reflectance and transmittance as shown in the table below:

| Wavelength nm | Reflectance | Transmittance |
|---|---|---|
| 280-420 | 0 to 15% | 0 to 15% |
| 421-700 | 40-95% | 5-50% |

In some embodiments the ground cover material comprises a mono-orientated or biaxially orientated reflective material comprising a polymer or polymers and at least one substantially white pigment, that when mixed with the polymer(s) to form a polymer/pigment mix, that when extruded and mono-orientated and/or biaxially-orientated, provides increased reflectivity relative to the same material without mono-orientation or biaxial-orientation of the polymer and pigment(s) mixture. The polymer/pigment mixture may be manufactured by treating a thick and wide plastic tape containing a pigment in a form allowing mono-orientation by stretching the tape to decrease its thickness and width and orientate the polymer(s) and pigment(s) mixture.

In some embodiments the material comprises one or more inorganic white UV absorbing pigments. In some embodiments, the material comprises one or more clear or substantially clear (when used in plastic film) inorganic UV absorbing pigment. In some embodiments, the material comprises one or more organic UV absorbing pigments. In some embodiments, the material comprises a combination of one or more inorganic white UV absorbing pigments and one or more organic UV absorbing pigments. In some embodiments the material comprises a combination of one or more inorganic white UV absorbing pigments, one or more clear or substantially clear (when used in plastic film) inorganic UV absorbing pigments, and one or more organic UV absorbing pigments.

In some embodiments, the organic UV absorber(s) may be chosen from the group consisting of benzotriazole, cyanoacrylates, phenylacrylate, oxanilides, benzophenones, hydroxyphenyltriazines, hyrdoxyphenylbenzotriazole, tri and octyl methoxycinnamate, aminobenzoic acid, aminobenzoate and oxybenzone.

In some embodiments, the inorganic white UV absorber(s) may be chosen from the group consisting of barium titanate, magnesium titanate, strontium titanate, neodymium titanate, tin oxide, titanium oxide, zinc oxide, zinc sulphide, zinc sulphate, zirconium silicate and magnesium oxide.

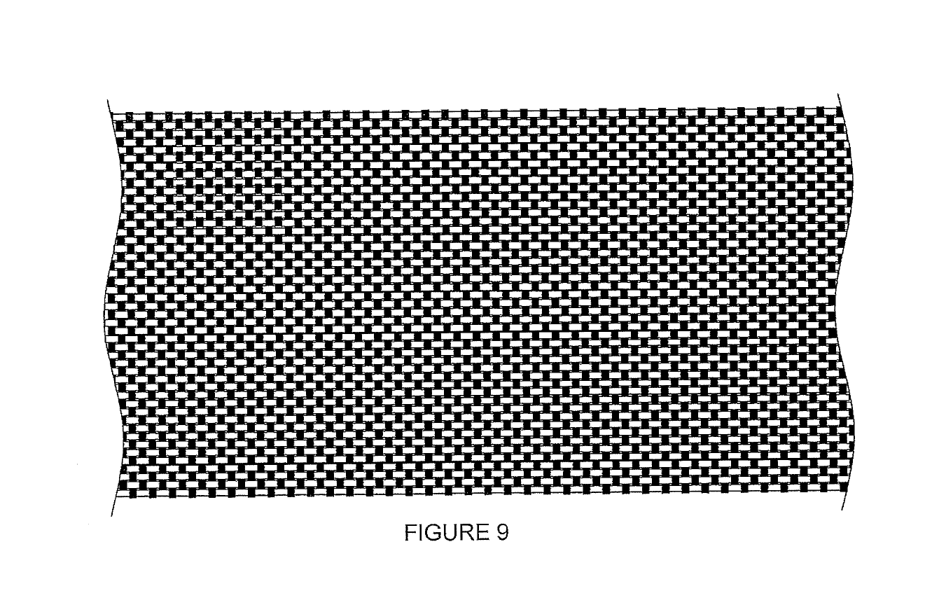

In a preferred embodiment, all of the warp tapes (running longitudinally) comprise a white pigmentation, and all of the weft tapes (running laterally) comprise a black pigment, as illustrated in FIG. 9. This results in a sheet material that has a combination of 50% white on black tapes and 50% black on white tapes.

A field trial was carried out to determine the effect that a cover material according to the embodiment of FIG. 9 has on soil temperature compared to black and white cover materials. The trial was set up in a newly planted blueberry orchard located in Washington State USA. A black ground cover material and a white UV reflecting ground cover material were compared to the black and white UV reflecting composite ground cover material consisting of a combination of tapes of the same tape as the black ground cover material and white ground cover material. All three cover materials had the same construction type. More specifically, each was comprised of tapes 2.6 mm wide and 50 microns thick (about 2000 g/9000 m denier) woven from flat warp and weft tapes. The cover had no gaps, holes, slits or openings greater than 1 mm in or between the tapes so as to minimise unwanted plant growth between the cover. The tapes were crammed to create folding in the tapes to close any gaps. The fabric weight was 105 grams per square meter. The fabric construction was 10.4 tapes per inch in the warp direction and 10.4 tapes per inch in the weft direction. The black ground cover material and white ground cover material only varied in the colour/pigment chemistry of tapes used in the construction of the materials. In the composite material, all the warp tapes were black and the weft were white.

The black tapes used a masterbatch in the form of thermoplastic granules containing 37% to 42% pigments of a combination of calcium carbonate, carbon black and a first polymer. The tapes were 50 micron oriented polyethylene tapes that were woven into the ground cover material.

Warp and weft tapes of the ground cover were formed by first extruding a second polymer, polyethylene, and the masterbatch containing the pigments of the invention at an addition rate of 3.5% masterbatch to 96.5% polyethylene on a cast extrusion line to form a film of about 200 microns. The resulting film was quenched in a water bath and drawn through rollers under tension to form a sheet. The sheet was then transported under tension to a slitting device with a plurality of knives and slit into a plurality of narrow slit tapes. The tapes were then stretched and mono-axially oriented by passing the tapes through two sets of heated rollers on either side of an oven with an air temperature set at 100 to 130 degrees Celsius. The second set of rollers is colder than the first set, and the speed of the second set of rollers is 5 to 7 times the speed of the first set of rollers, this enables stretching and molecular chain orientation to increase the strength of the tapes compared to unstretched tapes. The process of orienting the tapes reduced the thickness of the tapes from 200 microns to 50 microns. The warp and weft tapes in turn were then used to weave the ground cover material.

The white tapes used a masterbatch in the form of thermoplastic granules containing 65% to 70% pigments of a combination of calcium carbonate, titanium dioxide, zinc oxide, hydroxyphenol benzotriazole and a first polymer. The tapes were 50 micron oriented polypropylene tapes that were woven into the ground cover material.

Warp and weft tapes of the ground cover were formed by first extruding a second polymer, polypropylene, and the masterbatch containing the pigments of the invention at an addition rate of 33% masterbatch to 67% polypropylene on a cast extrusion line to form a film of about 200 microns. The resulting film was quenched in a water bath and drawn through rollers under tension to form a sheet. The sheet was then transported under tension to a slitting device with a plurality of knives and slit into a plurality of narrow slit tapes. The tapes were then stretched and mono-axially oriented by passing the tapes through two sets of heated rollers on either side of an oven with an air temperature set at 140 to 160 degrees Celsius. The second set of rollers is colder than the first set, and the speed of the second set of rollers is 7 times the speed of the first set of rollers, this enables stretching and molecular chain orientation to increase the strength of the tapes compared to unstretched tapes. The process of orienting the tapes reduced the thickness of the tapes from 200 microns to 50 microns. The warp and weft tapes in turn were then used to weave the ground cover material.

The blueberry orchard was set up with mounded rows approx. 0.5 m high and 1 m wide. The experimental set up involved using replicated plots for each cover material type. Each plot covered three rows across and 20 m along the row. Plots were replicated twice.

Plots were installed in spring. For each plot soil temperature at a depth of 20 cm was measured using data loggers for a period of 55 days during mid-summer, with data being captured every 30 minutes. Raw data was converted into daily mean, maximum and minimum temperatures for each ground cover material type.

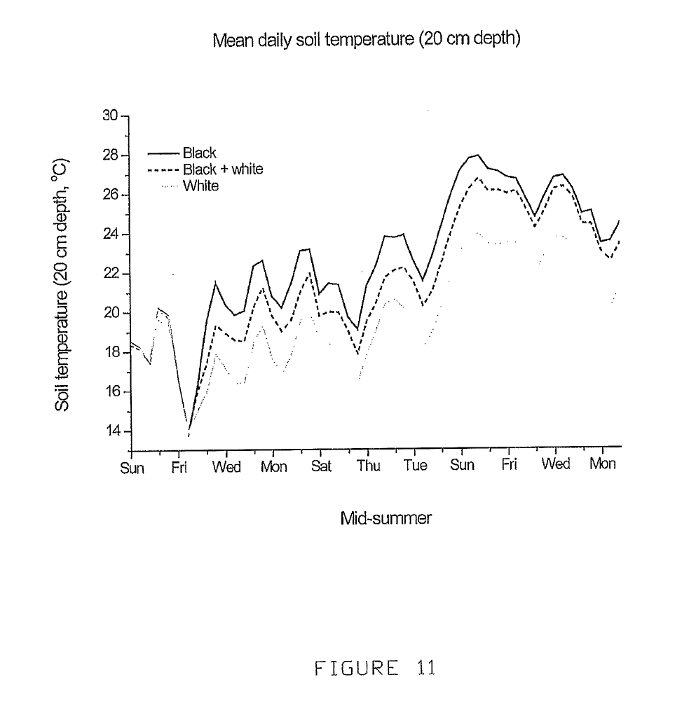

For the first 40 days of the 55 day sampling period, soil temperatures generally increased, then in the last 15 days the temperatures started to decrease again. Over this period there were consistent differences in the mean, maximum and minimum soil temperatures beneath each type of ground cover material. The results from the field trial are present in the table below and in FIG. 11 where a sample of the dates is provided as a graph.

TABLE 1
Ground cover material trial - mid-summer (June-
July) 55 day average soil temperatures (° C.)

| Temperature | Black | Black and white | White |
|---|---|---|---|
| Average mean temperature | 22.8 | 21.8 | 19.9 |
| Difference vs white material | +2.9 | +1.9 | — |
| Average maximum temperature | 25.8 | 24.4 | 22.5 |
| Difference vs white material | +3.3 | +1.9 | — |
| Average minimum temperature | 20.1 | 19.6 | 17.9 |
| Difference vs white material | +2.2 | +1.7 | — |

As can be seen from the data collected, the black ground cover material gave the warmest temperatures and the white cover material gave the coolest. The black & white composite ground cover material gave intermediate temperatures. Over the entire sampling period the black ground cover material was 2.9° C. warmer (daily mean temperature) than the white ground cover material, and the black and white composite ground cover material was 1.9° C. warmer than the white ground cover material.

The weed growth under the black, black and white material was adequate but under the white only material the weed growth was excessive. The black and white material was able to provide additional benefits over black of reflected light to support improved fruit quality. The excessive heat from the black produces excessive amount of shriveled berries but less in the black and white.

A further field trial was conducted to confirm the results of the above field trial, again using a ground cover material as illustrated in FIG. 9. The ground cover materials used in the trial were the same as those used in the trial discussed above.

The trial was set up on an orchard at Sunnyside, Washington State, USA during summer to gain temperature data from beneath the weed mats being assessed. Again, the black ground cover materials and white ground cover materials were compared to a ground cover material consisting of a combination of tapes of the same tape as the black ground cover material and white ground cover material.

The site chosen was on a south facing slope free of trees to intercept maximum sunlight. Soil type was a sandy loam. The trial rows were set up with flat beds, 1 m wide and 9 m long.

The ground cover materials were installed during late spring. Temperature data loggers (Multitrip Data Logger, Temprecord) were installed at a depth of 20 cm beneath each weed suppression mat treatment plot measuring soil temperature with data captured every 10 minutes. Data was collected from 26 Jun. to 30 Jul. 2014. The black and white composite material is referred to as chequerboard.

TABLE 2
Ground Cover Material Trial (Summer 2014)

| | Black | Chequerboard | White |
|---|---|---|---|
| June Mean | 22.7 | 21.9 | 20.7 |
| Difference compared | 2 | 1.2 | 0 |
| to White | | | |
| July Mean | 26.0 | 25.2 | 22.8 |
| Difference compared | 3.2 | 2.4 | 0 |
| to White | | | |
| Average for June- | 24.3 | 23.6 | 21.7 |
| July | | | |
| Difference compared | 2.6 | 1.8 | 0 |
| to White | | | |

Similar to the earlier trial, the soil beneath the black ground cover demonstrated the highest temperatures, with soil beneath the white demonstrating the lowest, and soil beneath the composite material demonstrating temperatures intermediate to the other two.

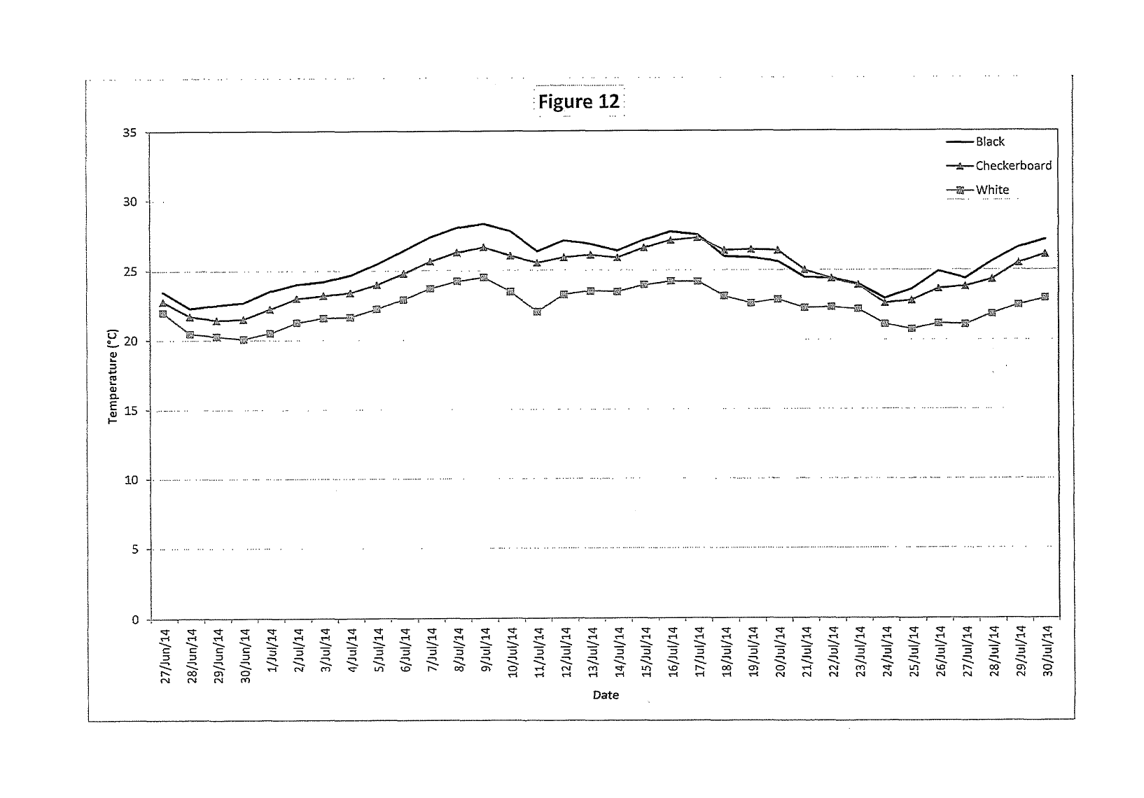

FIG. 12 illustrates graphically the effect of the different ground covers on mean soil temperature, using the same data as that upon which the above table was based. For a short period, the temperature of the soil beneath the chequerboard material is above the temperature of the soil beneath the black. While not wishing to be bound by theory, the applicant believes this to be due to the heat retention properties of the white tapes the difference became less over time.

The white only material showed weed growth beneath the fabric and is unsuitable for suppressing weed growth. The black and black/white shown good weed suppression.

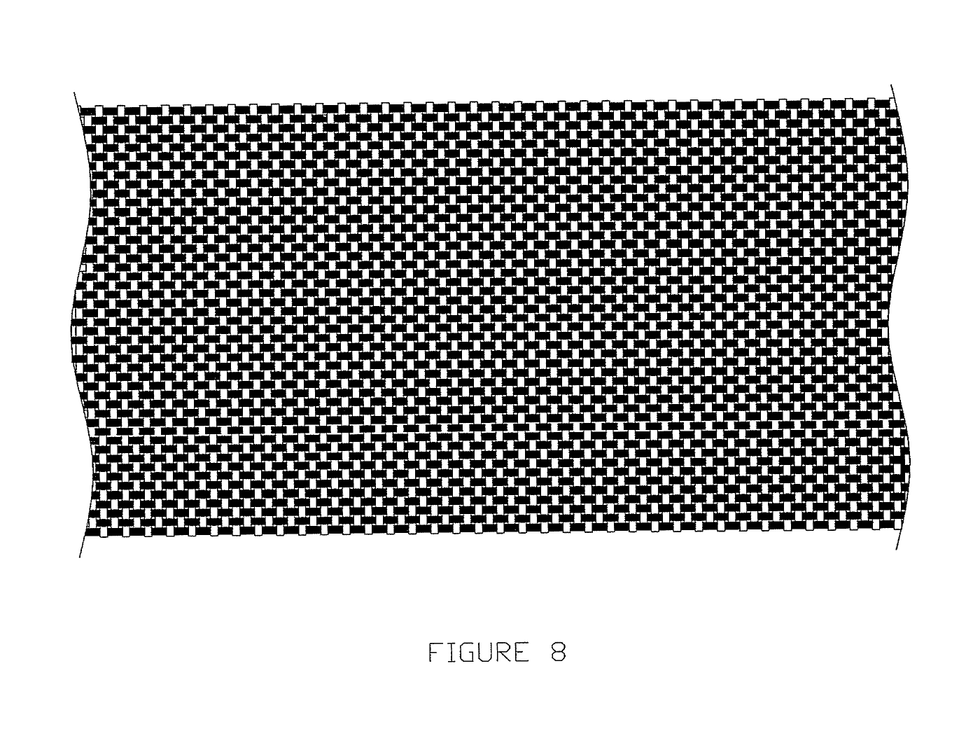

In an alternative construction, the warp tapes are black and the weft tapes are white as illustrated in FIG. 8, however, it is preferable to have black pigmented weft tapes and white pigmented warp tapes as illustrated in FIG. 9 as the weft tapes are more mechanically stressed during the weaving process, and black tapes are typically stronger due to black pigment loadings in the plastic tape material being lower than white pigment loadings.

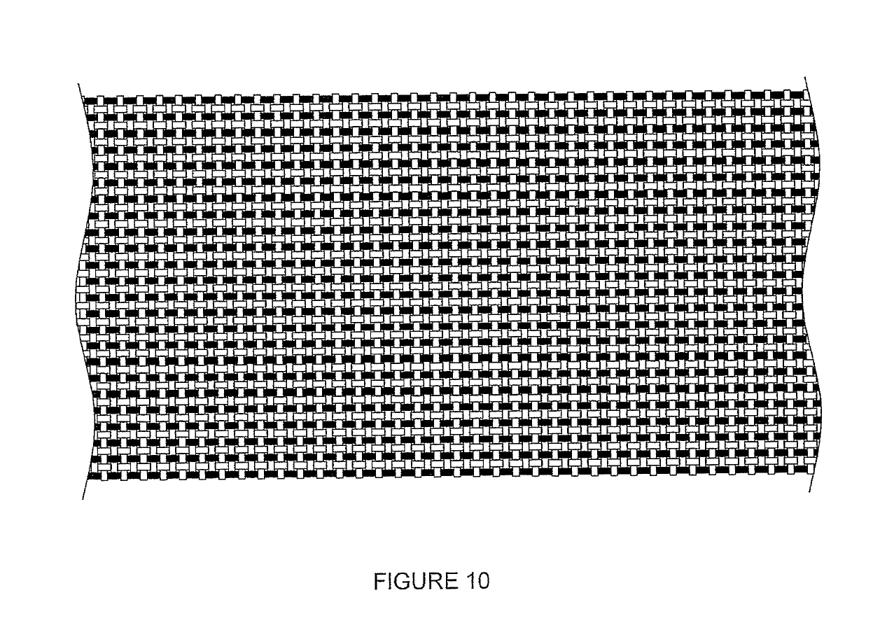

Variations can be created with two different types of tape. Instead of placing all of one type of tape into the warp, part could be placed into the weft and vice versa for another type of tape. For example, depending on the crop type and climate conditions, it may be useful to have a sheet material where the warp tapes are black alternated with white so that the material has 50% white on white tapes, 25% white on black tapes, 25% black on white tapes. This material, illustrated in FIG. 10, would have different reflectance and transmittance properties from the above described material where the white tapes were all in the warp and black tapes were all in the weft. This material would give a resulting temperature somewhere between the temperature results for the black and white material of FIG. 9 and a completely white ground cover material.

Further variations may be envisaged. For example, substantially all of the warp tapes may be formed from a first type of tape and at least some of the weft tapes may be formed from a different type of tape. Alternatively a majority of the warp tapes may comprise a first type of tape, and a majority of the weft tapes may comprise a second type of tape. By varying the configurations of a weave of different types of tapes, we can obtain a range of materials with varying reflectance, transmittance and absorption properties.

The above examples describe the use of separate dark and light pigmented tapes. However other combinations of coloured tapes may be useful. For example, combinations of separate tapes comprising unpigmented plastic, green, red and brown pigmented plastic. For example, a ground cover formed from black warp tapes and red weft tapes will provide a combination of both light blocking and red reflection attributes.

In some embodiments the ground sheet material comprises green tapes. A ground cover sheet comprising green pigmented tapes may provide useful horticultural benefits in some applications. Some available green pigments are phthalocyanine green, chrome oxide green, chrome oxide green and chrome oxide yellow, nickel titanate, hydrated chromium sesquioxide and perylene black (organic).

In a preferred embodiment the green tapes comprise pigments, such as phthalocyanine green, organic orange (benzimidazolone), and iron oxide, which do not change chemically when exposed for long periods, such as years, to solar radiation. This is desirable for extending the life of the product. Pigments which are affected by solar radiation, such as UV light, become increasingly less transparent over time when exposed to the solar radiation, particularly in the 700 nm-2500 nm range.

In some green tapes comprise a polymer and a combination of a green pigment such as phthalocyanine green, and an additional pigment, such as iron oxide, to form a polymer-pigment mixture. The inclusion of the iron oxide as an additional pigment with the green pigment supports the soil warming and weed suppression properties of the material.

In some embodiments the green tapes comprise a polymer and a combination of a green pigment such as phthalocyanine green, and an additional pigment such as organic orange (benzimidazolone), to form a polymer-pigment mixture. The inclusion of the benzimidazolone as an additional pigment with the green pigment supports the soil warming and weed suppression properties of the material.

In some embodiments green tapes comprise a polymer and a combination of a green pigment such as phthalocyanine green, and two additional pigments such as iron oxide and organic orange (benzimidazolone), to form a polymer-pigment mixture. The inclusion of the iron oxide and the benzimidazolone as additional pigments with the green pigment increases the transmittance of solar radiation in the 550-600 nm range and the 700-800 nm range, compared to the same polymer-pigment mixture without the benzimidazolone added.

In some embodiments the green tapes comprise a polymer and a combination of a green pigment such as phthalocyanine green, two additional pigments such as iron oxide and organic orange (benzimidazolone) and an additional pigment such as silica, to form a polymer-pigment mixture. The inclusion of the iron oxide and the benzimidazolone and the silica as additional pigments with the green pigment increases the transmittance of solar radiation in the 550-600 nm range and the 700-800 nm range and decreases the transmittance of blue light and red light, compared to the same polymer-pigment mixture without the benzimidazolone added. The addition of the silica may increase the ability of the ground cover sheet material to hold heat in the soil from radiation above 2500 nm, this is achieved by reflection, and this is particularly beneficial for preventing the soil temperature decreasing rapidly once the solar radiation source is removed.

Increasing the amount of solar radiation transmitted by the cover increases the ability of the material to warm the soil. However, with the addition of suitable additional pigments, the resulting ground cover material preferably at least partly absorbs solar radiation in the UV (about 280-400 nm) range and the visible (about 400-700 nm) range. For example, in some embodiments the material absorbs more blue light (about 440-490 nm) and more red light (about 620-780 nm) than green light (about 490-570 nm). This supports the suppression of weeds but allows useful light to pass though for soil warming. The benefit of a material that is particularly transparent to solar radiation in the range above 700 nm but which absorbs (blocks) more blue and red light than green, and that allows green light to reach the soil below, is that the material provides for soil warming while also suppressing weeds growing beneath the ground cover. Green light passing through the ground cover material allows the solar energy to be transmitted to the soil underneath where it is converted to heat on absorption by the soil. This is more energy efficient than black ground cover materials where the energy is converted to heat and then transferred to the soil by conduction or convection (the black stops light getting through in the 400-700 nm range). However, effectively blocking the red and blue light suppresses weed/plant growth below the ground cover but allowing a portion of the green light to be transmitted.

A ground cover comprising green tapes may be particularly desirable as being a colour that blends in with the surrounding plants or ground. However, adding a pigment to improve some properties of the material can detrimentally change the colour of the material. In some embodiments the ground cover material comprises a main colour pigment (for example a green pigment), an active co-pigment (for example iron oxide) to impart desired solar radiation transmittance, reflection and absorbance properties, and a colour adjusting co-pigment to correct the colour change of the material caused by the addition of the active co-pigment.

In a preferred embodiment, the ground cover material comprises green tapes comprising phthalocyanine green as a main colour pigment, iron oxide as an active pigment to affect the solar radiation transmittance, reflection and absorbance properties of the material, and organic orange (benzimidazolone), to provide a resulting polymer-pigment mixture comprising desired solar radiation properties and desired colour.

In some embodiments, the iron oxide is iron oxide red. The red iron oxide may be red Fe₂O₃ (heamatite). The iron oxide may in the form of micronized particles.

In particular in the 700-900 nm range, and more specifically the 700-800 nm range, and more specifically the 700-760 nm range, and even more specifically at the 700-750 nm range, the above pigment combination allows more transmission compared to existing green pigmented materials, which is good for increasing heat for soil warming. Also, the above pigment combination may provide a green that is closely matched to plant green colour so it is not offensive to look at, or blends in with the surrounding environment. Other greens may be more dark in colour which do not blend in as well or mimic green leaves as well.

In another embodiment, the green tapes comprise phthalocyanine green as a main colour pigment, iron oxide as an active pigment to affect the solar radiation transmittance, reflection and absorbance properties of the material, organic orange (benzimidazolone), to provide a resulting polymer-pigment mixture comprising desired solar radiation properties and desired colour, and silica to provide additional soil warming during the night.

### Example 1

### Green Tapes

This example used a masterbatch in the form of thermoplastic granules containing 20% to 25% pigments of phthalocyanine green (11.5% w/w), iron oxide (6 to 8% w/w) and organic orange (benzimidazolone) (5% w/w) and a first polymer. The tapes were 50 micron oriented polypropylene tapes that were woven into the ground cover sheet.

Green tapes of the ground cover were formed by first extruding a second polymer, polypropylene, and the masterbatch containing the pigments of the invention at an addition rate of 6% masterbatch to 94% polypropylene on a cast extrusion line to form a film of about 200 microns. The resulting film was quenched in a water bath and drawn through rollers under tension to form a sheet. The sheet was then transported under tension to a slitting device with a plurality of knives and slit into a plurality of narrow slit tapes. The tapes were then stretched and mono-axially oriented by passing the tapes through two sets of heated rollers on either side of an oven with an air temperature set at 140 to 160 degrees Celsius. The second set of rollers is colder than the first set, and the speed of the second set of rollers is 7 times the speed of the first set of rollers, this enables stretching and molecular chain orientation to increase the strength of the tapes compared to unstretched tapes. The process of orienting the tapes reduced the thickness of the tapes from 200 microns to 50 microns. The tapes in turn were then used to weave the ground cover sheet, together with other types of tapes as described herein.

Field Trial 1

To prove the effect of the green tapes, a ground cover material formed entirely from the green tapes was made. A field trial was conducted to determine the effect that green tapes according to the above example has on soil temperature compared to prior art black, prior art green and prior art white ground covers. The trial was set up on a blueberry farm in Moxee, Washington State, USA during spring to gain temperature data from beneath the weed mats being assessed. Green ground covers were compared to black weed suppression ground covers. All covers were made of polyethylene or polypropylene, had the same construction type and only varied in the colour/pigment chemistry of tapes used in their construction. More specifically, each was comprised of tapes 2.6 mm wide and 50 microns thick (about 2000 g/9000 m denier) woven from flat warp and weft tapes to give a resulting fabric of around 105 grams per square meter. The cover had no gaps, holes, slits or openings greater than 1 mm in or between the tapes so as to minimise unwanted plant growth between the cover. The tapes were crammed to create folding in the tapes to close any gaps. The fabric weight was 105 grams per square meter. The fabric construction was 10.4 tapes per inch in the warp direction and 10.4 tapes per inch in the weft direction.

The site chosen was part of an existing blueberry farm on a flat area facing east/west. Soil type was a sandy loam. The treatment plots were set up with mounded rows approximately 0.5 m high and 1 m wide. The experimental set up involved using replicated plots for each cover material type. Each plot was 15 m long and had 20+ individual bushes spaced at 0.75 m. There were a total of three rows per treatment, the two outside rows used as guard rows and centre row only used for assessments.

The ground covers were installed during early spring of the year 2012 when the plants were first planted. Temperature data loggers (Multitrip Data Logger, Temprecord) were installed at a depth of 20 cm beneath each ground cover treatment plot measuring soil temperature with data captured every 45 minutes.

Results

Table 3 below is a comparison of mean soil temperatures for Spring Summer and Fall 2013 of a prior art black ground cover compared to a prior art green ground cover. The table 3 shows slightly higher mean ground temperatures resulted from use of the black ground cover. Data is presented in degrees celcius.

TABLE 3

| Season | Black | Prior Art Green |
|---|---|---|
| Spring (April-May 2013) | 15.0 | 14.9 |
| Summer (June-July 2013) | 23.5 | 23.4 |
| Fall (September-October 2013) | 15.9 | 15.9 |
| Weighted Average for 3 | 18.9 | 18.8 |
| Periods | | |
| Difference compared to | 0 | −0.1 |
| Black | | |

The slightly higher mean of the black is a result of high absorbance of solar radiation, resulting in the heating of the material itself and this heat being passed to the ground beneath by conduction or convection.

Table 4 below is a comparison of mean soil temperatures for Spring and Summer 2014 of a prior art black ground cover compared to a prior art green ground cover. The table shows higher mean ground temperatures resulted from use of the black ground cover. Data is presented in degrees celcius.

TABLE 4

| Season | Black | Prior Art Green |
|---|---|---|
| Spring (April-May 2014) | 15.6 | 15.1 |
| Summer (June-July 2014) | 22.9 | 22.6 |
| Weighted Average for 2 | 19.3 | 18.9 |
| Periods | | |
| Difference compared to | 0 | −0.4 |
| Black | | |

The higher mean of the black is a result of high absorbance of solar radiation, resulting in the heating of the material itself and this heat being passed to the ground beneath by conduction or convection. The warmer sunny season of 2014 is showing a greater difference between the black over the prior art green.

Table 5 below is a comparison of mean soil temperatures for summer 2014 of the same prior art black and prior art green materials as above and including the new green ground cover material of example 1 above. The soil warming properties of the green ground cover of the invention are greater than either the black or prior art green ground covers. The higher mean of the green ground cover is a result of the high transmittance of infrared radiation and also high transmittance of green light heating the soil directly. Data is presented in degrees celcius,

TABLE 5

| Summer Month | Example 1 Green | Black | Prior Art Green |
|---|---|---|---|
| June 2014 | 22.1 | 21.2 | 20.1 |
| July 2014 | 25.3 | 24.6 | 24.3 |
| Weighted Average | 23.7 | 22.9 | 22.6 |
| Difference compared | 0.8 | 0 | −0.2 |
| to Black | | | |

Field Trial 2

A further field trial was conducted to determine the effect that the green tapes of example 1 would have on soil temperature compared to prior art black and prior art white ground tapes. The trial was set up in Sunnyside Washington State, USA during summer to gain temperature data from beneath the ground covers being assessed.

Again, all three covers had the same construction type and only varied in the colour/pigment chemistry of tapes used in their construction. More specifically, each was comprised of tapes 2.6 mm wide and 50 microns thick (about 2000 g/9000 m denier) woven from flat warp and weft tapes. The cover had no gaps, holes, slits or openings greater than 1 mm in or between the tapes so as to minimise unwanted plant growth between the cover. The tapes were crammed to create folding in the tapes to close any gaps. The fabric weight was 105 grams per square meter. The fabric construction was 10.4 tapes per inch in the warp direction and 10.4 tapes per inch in the weft direction.

The trial site was on a south facing slope free of trees or other plants that may otherwise intercept sunlight. Soil type was a sandy loam. The trial rows were set up with flat rows, 1 m wide and 9 m long.

The ground covers were installed during late spring. Temperature data loggers (Multitrip Data Logger, Temprecord) were installed at a depth of 20 cm beneath each ground cover treatment plot measuring soil temperature with data captured every 10 minutes. Raw data was converted into daily mean, maximum and minimum temperatures for each ground cover type.

Over the period of the trial, there were consistent differences in the mean, maximum and minimum soil temperatures beneath each type of weed suppression mat. The results of the mean temperatures are presented in Table 6 below. Similar to the trial discussed above, the green ground cover of the invention produced significantly higher soil temperatures than the prior art black ground cover. The white ground cover was included for further comparison purposes. The results relating to the white show significantly lower temperatures than either the green or the black. Data is presented in degrees celcius.

TABLE 6

| Summer Month | Example 1 Green | Black | White |
|---|---|---|---|
| June 2014 | 23.7 | 22.7 | 20.7 |
| July 2014 | 26.5 | 25.8 | 22.5 |
| Weighted Average | 26.2 | 25.4 | 22.3 |
| Difference compared | 0.9 | 0 | −3.1 |
| to Black | | | |

Significantly less weed growth was observed under both the black ground cover and green ground cover than under the white ground cover. The white ground cover is not suitable to sufficiently suppress weeds in this situation where there is no crop to reduce the solar radiation on the material.

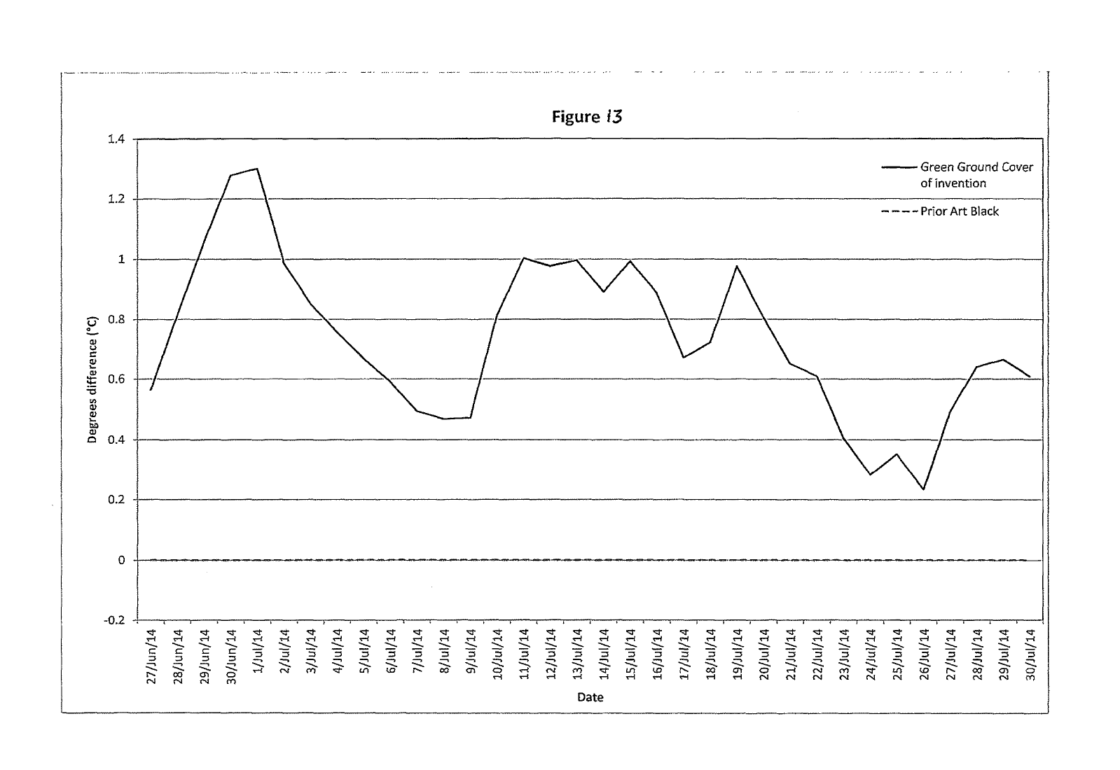

FIG. 13 illustrates data from the above trial shown in graphical form. In the figure, the green ground cover of the invention has been compared to the black ground cover, using the temperature data from the black ground cover as a baseline. The figure shows a mean daily soil temperature for the green ground cover of the invention being consistently higher than the black ground cover.

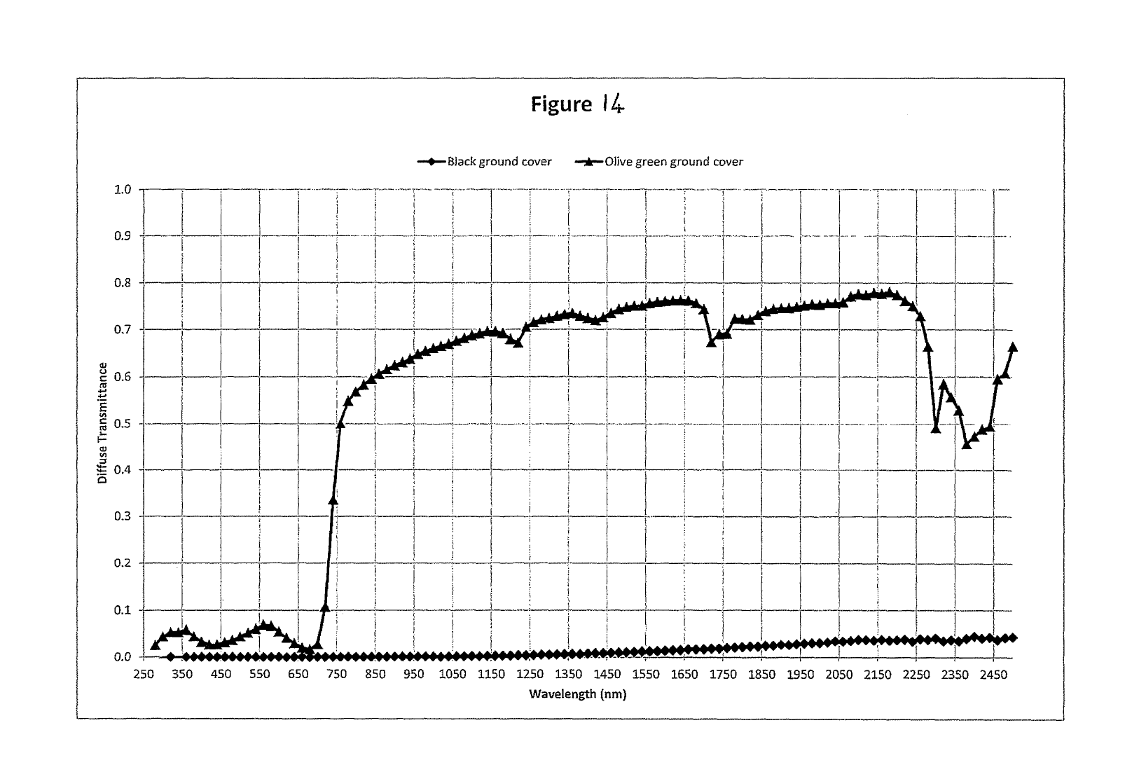

FIG. 14 is a graph comparing diffuse transmission data of a prior art green ground cover material compared to a prior art black ground cover material. The graph shows the low transmittance of the black ground cover material across the visible (400-700 nm) wavelengths. It is an effective weed suppression ground cover material and this is a result of low transmission across these wavelengths. The prior art green ground cover material also has low transmission across the visible wavelengths and is also an effective weed suppressant. Despite the difference in transmission profile between the ground cover materials, they provide generally similar the same soil warming properties as the black.

The black absorbs all of the solar radiation and converts it to heat that is then conducted to the soil. The prior art green allows the transmission of solar radiation beyond the 750 nm wavelengths to gain a similar resulting transference of solar radiation, the final soil temperature results, to the soil but by a different method.

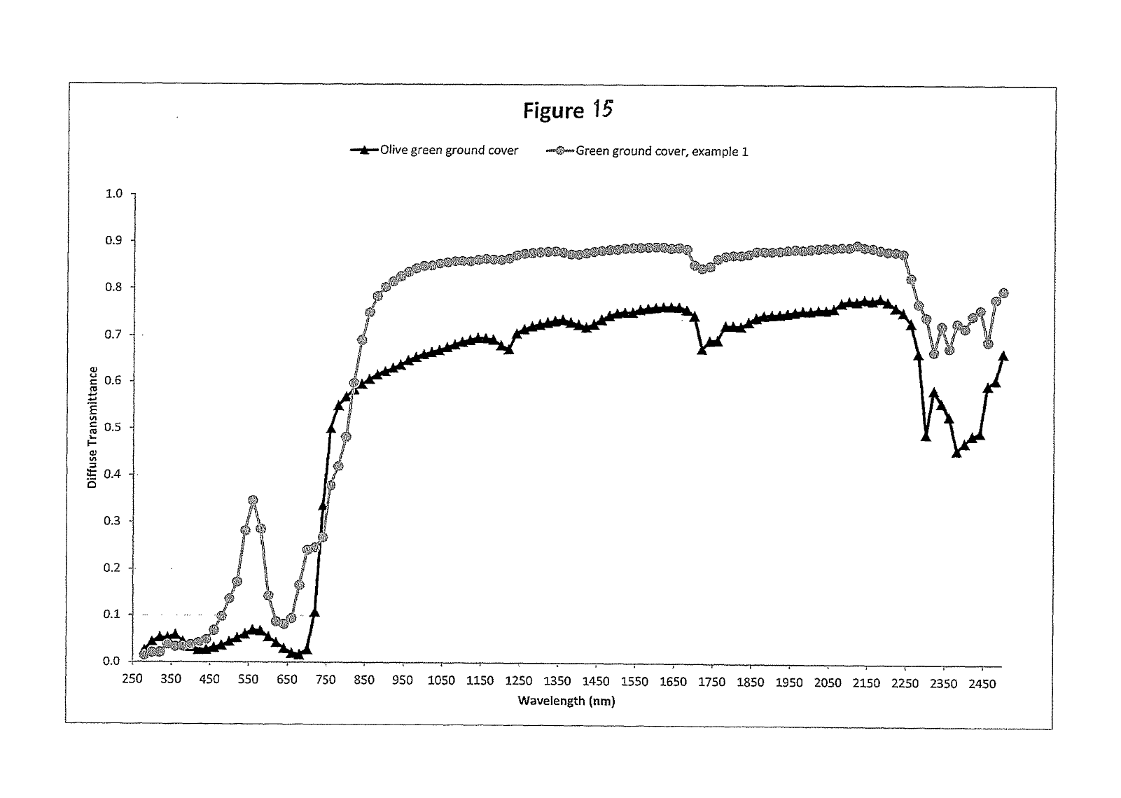

FIG. 15 is a graph comparing diffuse transmission data of a prior art green ground cover materials compared to the green ground cover material of example 1. Higher transmittance can be seen for the green ground cover material of example 1 across the wavelengths from about 400 to about 740 nm and also 780 nm to 2100 nm, and higher. In particular, there is significantly higher transmittance across the green wavelengths (490-570 nm), and 780 to 2100 nm, and above. These properties result in the green ground cover material of example 1 providing soil warming benefits to soil beneath the ground cover sheet. Also, transmission across the blue (440-490 nm) and red (620-700 nm) wavelengths is still relatively low, which means effective weed suppression. This gives the green cover material similar weed suppression results of the prior art green but higher soil warming properties.

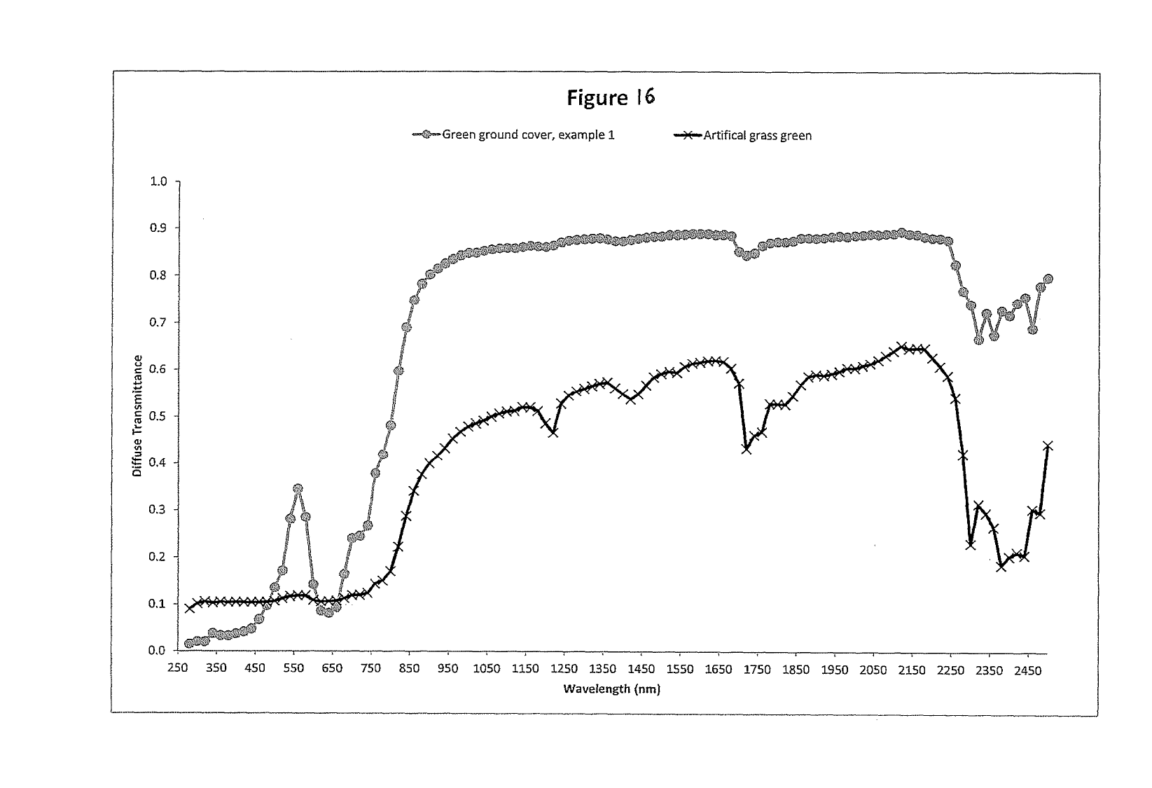

FIG. 16 is a graph comparing diffuse transmission data of an “artificial grass” coloured green ground cover material compared to the green ground cover material of example 1. Both materials have a similar visual appearance to the human eye, they look like green leaf color materials. Transmittance across the green wavelengths (490-570 nm) and across wavelengths greater than about 700 nm is significantly higher for the green ground cover material of example 1 than the artificial grass green. The green ground cover of example 1 provides significantly better soil warming due to this difference. The graph also shows the relatively high transmittance across the wavelength range 700 to 760 nm. While not wishing to be bound by any particular theory, the applicant of the present application believes that the high transmittance across this range is important for providing the soil warming benefits that the present invention may provide.

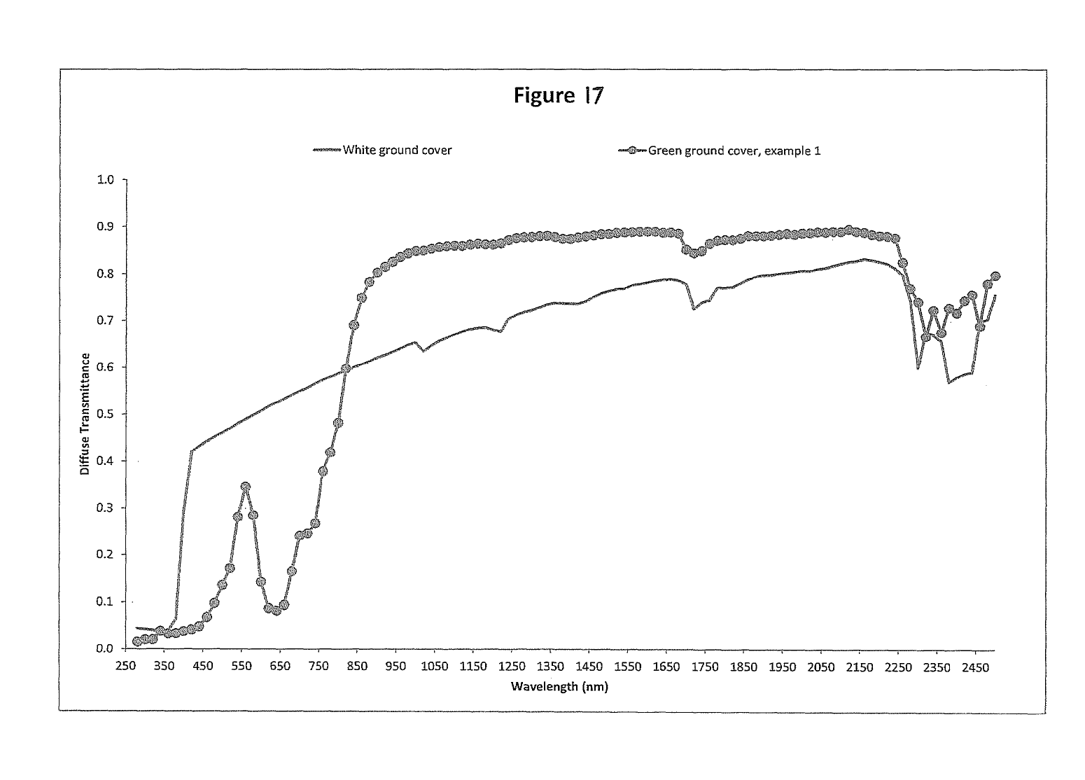

FIG. 17 is a graph comparing diffuse transmission data of a prior art white ground cover material compared to the green ground cover material of example 1. The graph shows much greater transmission of the white ground cover material across the 400-700 nm range, and therefore a poor weed suppression, and much lower transmission across the 800-2100 nm range, and therefore poor soil warming compared to green ground cover material of example 1.

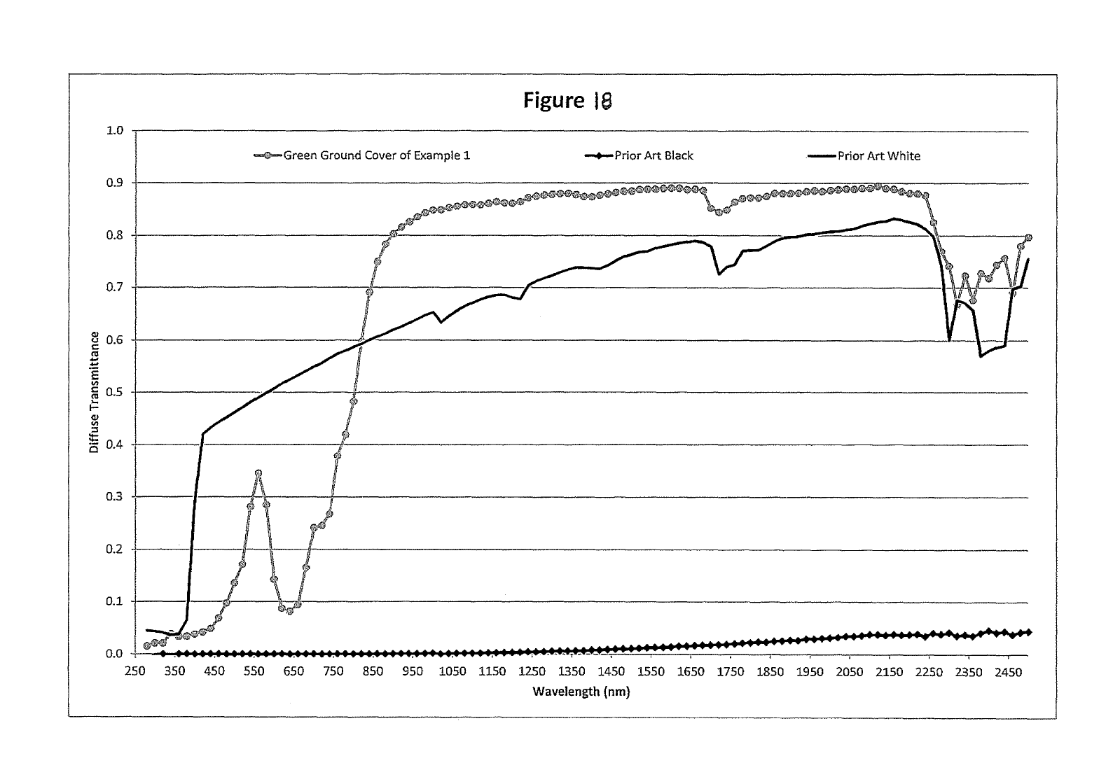

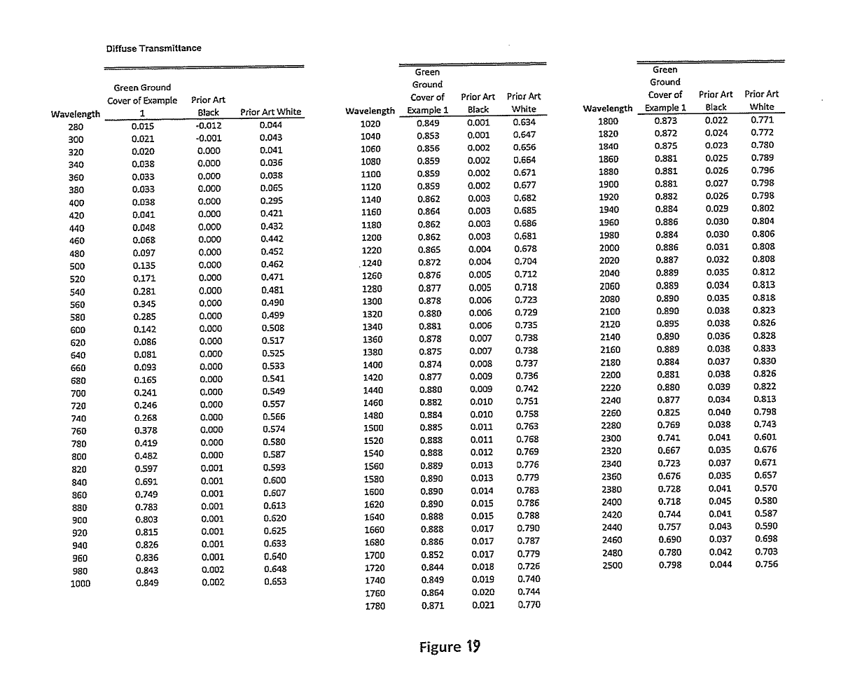

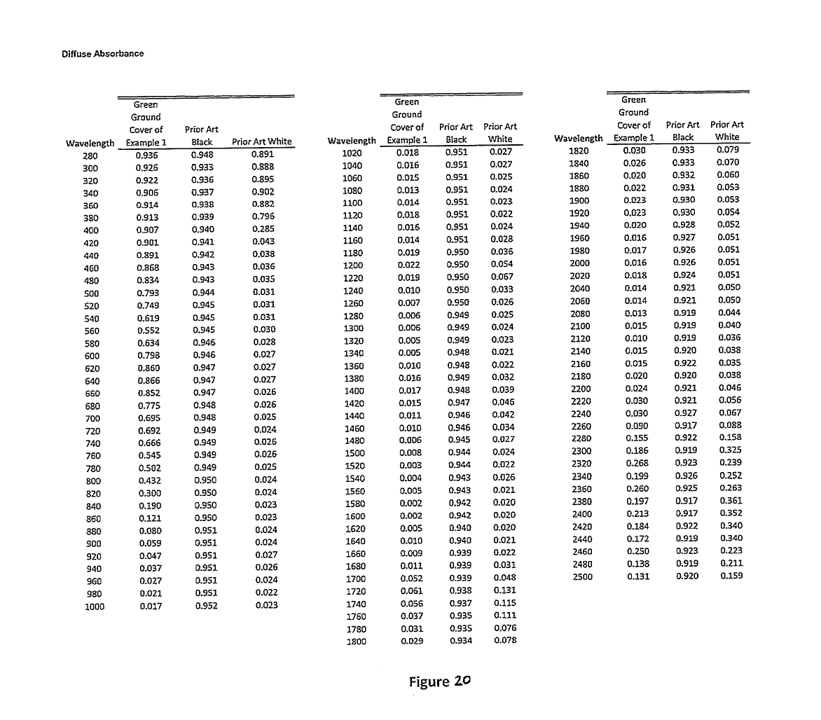

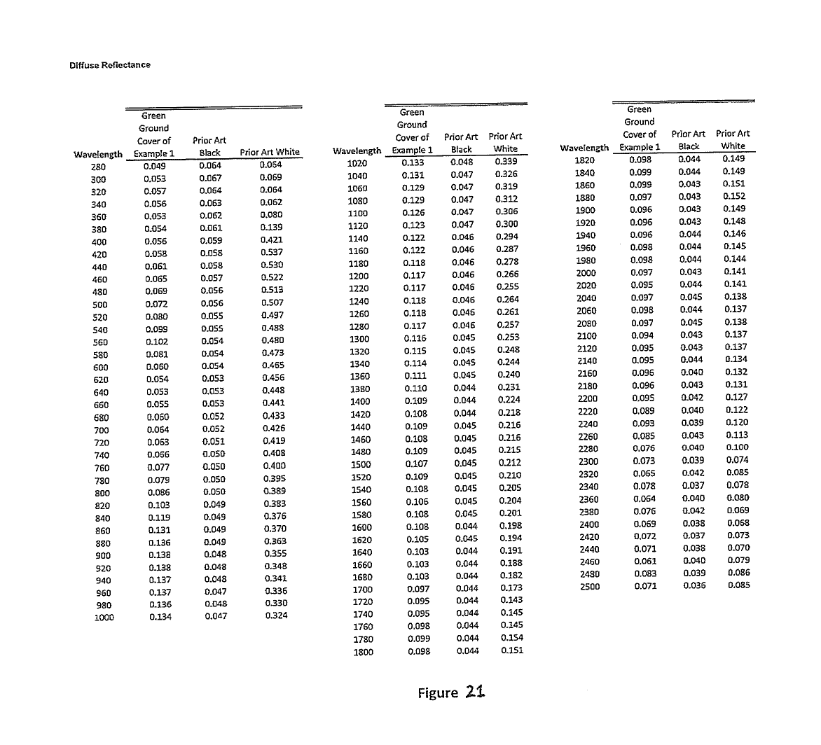

FIGS. 18 to 21 are a graph and tables comparing transmittance, absorbance and reflectance of the green ground cover material of example 1 above to a prior art black ground cover material and a prior art white ground cover material. With reference to FIG. 9 in particular, it can be seen that the prior art black material transmits very little visible (400 to 700 nm) solar radiation. It is an effective weed suppression ground cover and this is a result of its low transmission properties. In contrast, the prior art white material can be seen to have relatively high transmittance of visible solar radiation, and its poor weed suppression is a result of this. The green ground cover material of example 1 is shown as having low transmission across blue and red light, but higher transmittance of green light. This transmission profile allows the green ground cover material of example 1 to act as an effective weed suppressant. Further, transmission of radiation of wavelengths above 700 nm is also high for the green ground cover material of example 1, allowing effective soil heating to occur as well.

The preferred colour of the green tapes has CIELAB coordinates of L*=32.1, a*=−6.64, b*=4.13 or within a delta-E value of 6, 12, 18 or 24 of these coordinates.

In some embodiments the ground cover material comprises a first type of tape of a first colour, a second type of tape of a second colour, and a third type of tape of a third colour. By example, in some embodiments, the first colour is green and the second colour is tan. For example, tapes of the first colour are formed from a green coloured synthetic polymer, and tapes of the second colour are formed from a tan coloured synthetic polymer. Such colours may be particularly useful in a drape netting to be draped over a row of plants or trees or vines. The different colours of the netting material preferably cause the netting material to blend into plants or trees that the netting material is covering. The netting material therefore in preferred embodiments acts predominantly as a mechanical barrier against for example insects and birds. Preferably the netting blends in with the plants and trees so that the netting is less visually noticeable compared to prior art netting materials that are for example formed from white yarns.

In some embodiments the third colour is a blend of the first and second colours. For example, in one embodiment, the yarns of the third colour are formed from a polymer that is a blend of 20% of the coloured polymer of the green coloured yarns and 80% of the coloured polymer of the tan coloured yarns. For example, in some embodiments each yarn is formed from a polymer comprising a masterbatch loading of 6% by weight. For the yarns of the third colour, the yarn may be formed from a polymer and a masterbatch at 6% by weight in the polymer, the masterbatch comprising 20% of the green masterbatch for the green yarns and 80% of the tan masterbatch for the tan yarns.

In some embodiments the first colour is Pantone green 627U, the second colour is Pantone tan 7502U, and a 20%:80% blend of the first and second colours gives a Pantone colour of 581U for the third colour. The third colour may be described as an colour similar to olive green. These particular colour combinations have been found to be particularly useful.

The green colour is preferably similar in colour to green leaves, and the tan preferably similar in colour to the colour of a vine trunk and branches, while the blended color is similar to the colour of stems of the vine. The green colour takes up an area of the material similar to an area of the green leaves of the plant, the tan similar in area to the vine trunk and branches and the blended color the vines stems. Thus the fabric mimics the plant itself in color and area taken up by each colour.

In some embodiments the green is a colour with CIELAB colour space coordinates L*, a*, b* of 32.1, −6.64 and 4.13. That is, for a preferred green colour the coordinates L*, a*, b* are about 32, −6.6 and 4.1.

In some embodiments the tan is a colour with CIELAB colour space coordinates L*, a*, b* of 65.82, 6.62 and 18.29. That is, for a preferred tan colour the coordinates L*, a*, b* are about 66, 6.6 and 18.3.

In some embodiments the blended colour of green and tan is a colour with CIELAB colour space coordinates L*, a*, b* of 50.27, −1.53 and 16.75. That is, the CIELAB coordinates L*, a*, b* are about 50, −1.5 and 16.8.

Other colour combinations may be useful. For example, the first colour is green and the second colour is grey. For example, tapes of the first colour are formed from a green coloured synthetic polymer, and tapes of the second colour are formed from a grey coloured synthetic polymer. This can be useful in an environment that is particularly dusty where in prior art netting materials that are white can become discoloured to look a dirty grey colour. The grey of the netting material disguises any dust or dirt that lies on the netting material and so the netting material looks fresher or newer for a longer period. Further, the green of the netting material may blend in to the foliage of the trees or plants being covered or screened. Some particular colour combinations that have been found to be useful are Pantone green 627U and Pantone grey 426U. For these colours, tapes of the third colour are preferably a blend of 80% of the green and 20% of the grey. Other blend options may be useful, for example a blend containing equal parts of the first and second colour.

In some embodiments tapes of the first colour are formed from a tan coloured synthetic polymer, and tapes of the second colour are formed from a grey coloured synthetic polymer. Tapes of the third colour are preferably a blend of tan and grey, for example a blend comprising equal parts of the first and second colour.

In some embodiments grey tapes comprise a masterbatch comprising a ratio of 1 part black to 10 parts white. In some embodiments the grey colour is a grey mixed with tan to give a grey that appears to be soiled or dirty. A ‘dirt-grey’ colour that is considered to be particularly useful is a colour with CIELAS colour space coordinates L*, a*, b*, h° and C* of 49.22, 0.15, 3.25, 3.25 and 87.41. That is, for a preferred grey colour the coordinates L*, a*, b* are about 49, 0.2 and 3.3. The inventor considers this colour and colours of similar hues, chrome and lightness also to be particularly useful for blending in with the natural environment, and/or for disguising dirt, dust or debris deposited on the material.

Other colours of similar hues or lightness are also considered useful as a grey colour in a agricultural fabric. For example, in some embodiments, the tapes of the second colour may be of a colour having a lightness L* in the range of 43 to 55, or in the range of about 45 to 53, or about 47 to 51, or about 48 to 50. In some embodiments, a* may be in the range of about −1 to 2, or −1 to 1, or −0.5 to 0.5, or about 0 to 0.25. In some embodiments, b* may be in the range of about 3 to 3.5, or about 3.1 to 3.4, or about 3.2 to 3.3.

In some embodiments the dirt-grey colour described may be used in the material as the second colour together with tan or green as the first colour.

In some embodiments the green is a colour with CIELAB colour space coordinates L*, a*, b* of about 32, −6.6 and 4.1. The grey is a colour with CIELAB colour space coordinates L*, a*, b* of about 49, 0.2, 3.3. In some embodiments a colour that is a blended colour of green and grey is a colour with CIELAB colour space coordinates L*, a*, b* of about 41, −2 and 3.7.

In some embodiments the tan is a colour with CIELAB colour space coordinates L*, a*, b* of about 66, 6.2 and 18.3. The grey is a colour with CIELAB colour space coordinates L*, a*, b* of about 49, 0.2, 3.3. In some embodiments a colour that is a blended colour of tan and grey is a colour with CIELAB colour space coordinates L*, a*, b* of about 55, 3 and 12.

In some embodiments the first colour is tan, for example Pantone 7502U or a colour with L, a*, b* coordinates of about 66, 6.2, 18.3, and the second colour is a grey-black colour with CIELAB colour space coordinates L*, a*, b*, h° and C* of 39.65, −0.53, −3.42, 3.46 and 261.22. That is, coordinates L*, a*, b* are about 40, −0.5 and −3.4. The inventor considers this colour and colours of similar hues, chroma and lightness to be particularly useful for blending in with the natural environment, and/or for disguising dirt, dust or debris deposited on the material.

Colours of similar hues or lightness are also considered useful. For example, in some embodiments, the tapes of the second colour may be of a colour having a lightness L* in the range of 34 to 46, or in the range of about 36 to 44, or about 38 to 42, or about 39 to 41. In some embodiments, a* may be in the range of about −1.5 to 0.5, or −1 to 0, or −0.75 to −0.25. In some embodiments, b* may be in the range of about −3.7 to −3.15, or about −3.6 to −3.2, or about −3.5 to −3.3.

In some embodiments, the third colour that is a blend of the colours grey-black and tan is the ‘dirt-grey’ colour described above having L, a*, b* coordinates of about 49, 0.2 and 3.3.

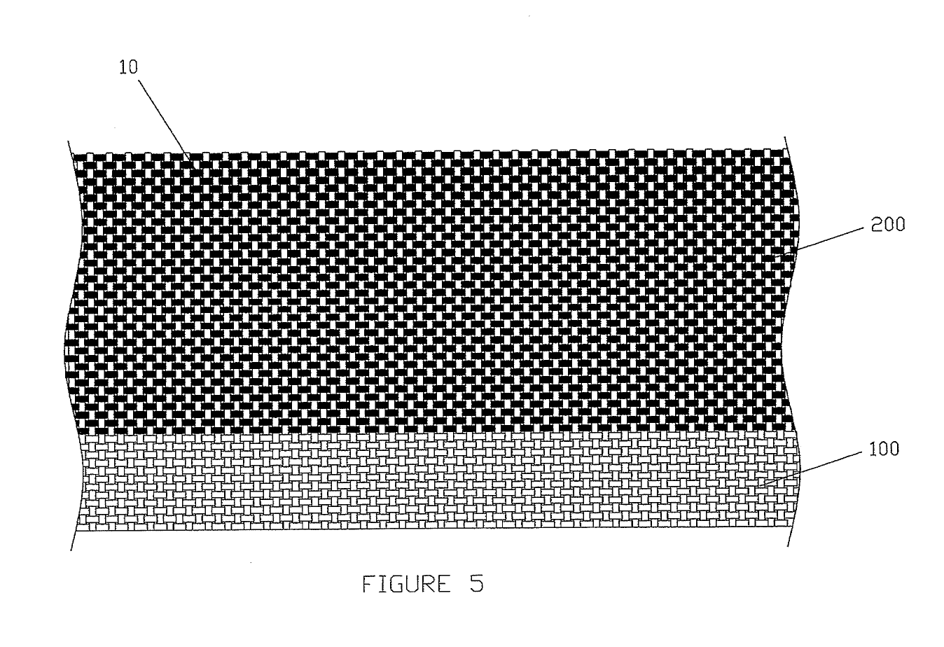

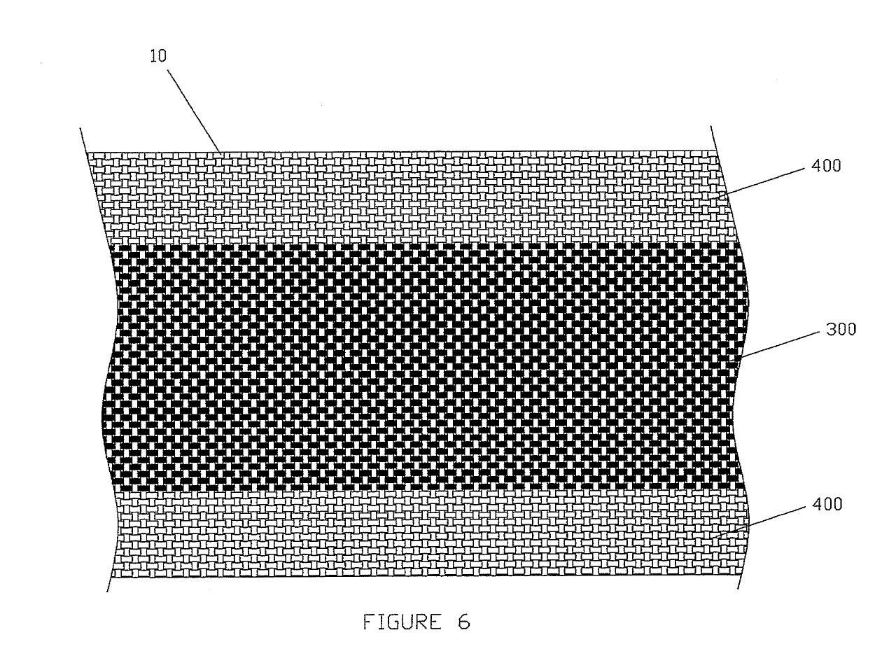

The separation of the different types of tapes can also have application across the width of the ground cover. This has application where it is desirable to vary the reflectance and/or transmittance properties across the ground cover. For example, in an orchard of fruit trees, the cover that is in or nearest to the centre of the distance between two adjacent trees or rows of trees could have more black tapes for weed suppression where there is more sunlight, while the ground cover under the tree has more white tapes to reflect more light in areas where there is less sunlight due to tree coverage and therefore less weeds. In certain climates it may also be preferable to have more white tapes in the material that is positioned in or nearest to the centre of the distance between two adjacent rows of trees where there is more sunlight, to reduce soil temperature, and more black tapes under tress where there is less sunlight and therefore where higher soil temperature is less of an issue.

Where ground sheets are used in an orchard as shown on the left side of FIG. 2a, it may be preferable to have a side portion or region 100 of the width of the sheet material adjacent a longitudinal side of the sheet material formed from white tapes, and the remaining width 200 of the sheet material formed from black tapes. This configuration can be achieved by having the warp tapes in the side region 100 of the sheet comprising white pigment, and the warp tapes in the remaining width 200 of the sheet comprising black pigment. The weft tapes could be black or white depending on the desired effect for the ground cover material, the illustrated embodiment showing white weft tapes. The side region of the sheet comprising the white pigmented warp tapes would be located against and under a tree as illustrated schematically in FIG. 2a by the thicker part 100 of the sheet material 10. A sheet according to this embodiment is illustrated in FIG. 5. The side portion 100 may extend for at least 10% or 20% or 30% or 40% or 50% of the width of the ground cover sheet material. In an alternative embodiment, area 100 comprises black warp tapes and the remaining width 200 comprises white warp tapes.

Where ground sheets are used in an orchard as shown on the right side of FIG. 2a between rows of trees, it may be preferable to have a central portion 300 of the width of the sheet material formed from black tapes, and the remaining width 400 of the sheet material either side of the central portion 300 formed from white tapes. This configuration can be achieved by having the warp tapes in the central region 300 of the sheet comprising black pigment, and the warp tapes in the remaining width 400 of the sheet comprising white pigment. In use, the central black portion of the sheet is located approximately centrally between the rows of trees as illustrated schematically in FIG. 2a by the thicker part 300 of the sheet material 10. A sheet according to this embodiment is illustrated in FIG. 6. The central region or portion 300 may extend for at least 10% or 20% or 30% or 40% or 50% or 60% or 70% or 80% of the width of the ground cover sheet material. In an alternative embodiment, the area 400 comprises black warp tapes and the remaining width 300 comprises white warp tapes.

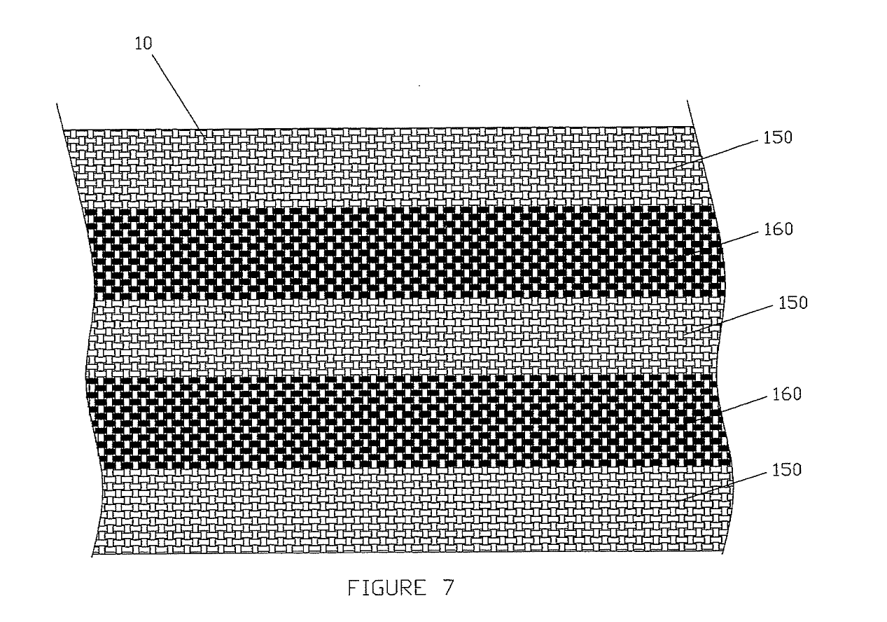

As explained above, in some embodiments of the invention, some of the warp tapes are formed from the one type of tape and other warp tapes are formed from another type of tape. Other arrangements of different types of warp tapes may be useful. For example, the warp tapes may be formed into groups of warp tapes formed from one type of tape. These groups of tapes are spaced apart by groups of tapes formed from another type of tape. An example of this embodiment is illustrated in FIG. 7, where groups 150 of warp tapes of a first type of type are spaced apart by alternate groups 160 of warp tapes of a second type of tape. For example, areas 150 may comprise warp tapes comprising a white pigment and areas 160 may comprise warp tapes comprising a black pigment. Alternatively, areas 150 may comprise warp tapes comprising a black pigment and areas 160 may comprise warp tapes comprising a white pigment. Each group of tapes may extend for 10% or more of the width of the sheet material. Further, in FIG. 7, groups 150 and 160 are shown as having the same or similar widths, however, in alternative embodiments, groups 150 comprising the first type of tape may be wider or narrower than groups 160 of tapes comprising the second type of tape.

Another useful tape characteristic to vary to achieve different reflectance, transmittance and absorption properties of the tape is the tape thickness. For example a thicker tape is more useful for weed suppression being superior in the blocking of light compared to a thinner tape. For example, with reference to the right side of FIG. 2a and FIG. 6, a sheet according to one embodiment comprises a central portion 300 of the width of the sheet material formed from thick tapes, and the remaining width 400 of the sheet material either side of the central portion 300 formed from thin tapes, where less blocking of light is required. Furthermore, the thinner tapes in the side regions 400 may also comprise a different pigmentation to the tapes in the central portion, the side regions comprising white tapes and the central thick portion comprising black tapes. This configuration can be achieved by having the warp tapes in the central region 300 of the sheet comprising thicker black pigmented tapes, and the warp tapes in the remaining width 400 of the sheet comprising white pigmented thinner tapes. Also, in this case, it may be preferably to include peripheral regions directly adjacent the longitudinal edges of the ground cover material to create reinforced edges of the cover material for attaching or securing to the ground or to the trees. In this embodiment, the cover material comprises thicker tapes in the central portion and in peripheral regions, and thinner tapes in intermediate portions in between the central portion and each peripheral portion. The thicker tapes in the peripheral region are located adjacent the edges of the cover material to be localised to the fixing area of the cover material. For example, the thicker peripheral areas may extend inwards from the longitudinal edge of the cover material by 100 mm or less.

Thicker tapes are preferred for absorbing light for warming soil in colder climates. However, thicker tapes may not be required in areas of sheet material that is located in direct sunlight compared to areas that are located in the shade of a plant or tree. For example, in some applications it may be preferable to have thinner tape in a central portion 300 of the ground cover material and thicker tapes in side regions 400 either side of the central region of the material.

Thicker and thinner tape variations can also be used to vary the needed strength for the areas of more wear, such as tractor traffic in the central areas of the ground cover material, for example having thicker tapes in two strips to cover where the wheels of a tractor may traverse over the surface. Also, the centre area, being exposed to more light, may comprise heavier tapes to provide a more durable material to give a longer product life. Further, the white tapes could also be thicker as white tapes tend to not be as light stable as the black tapes, and by being thicker, the life of the white tapes is improved, for example to be the same as or similar to the life of the black tapes.

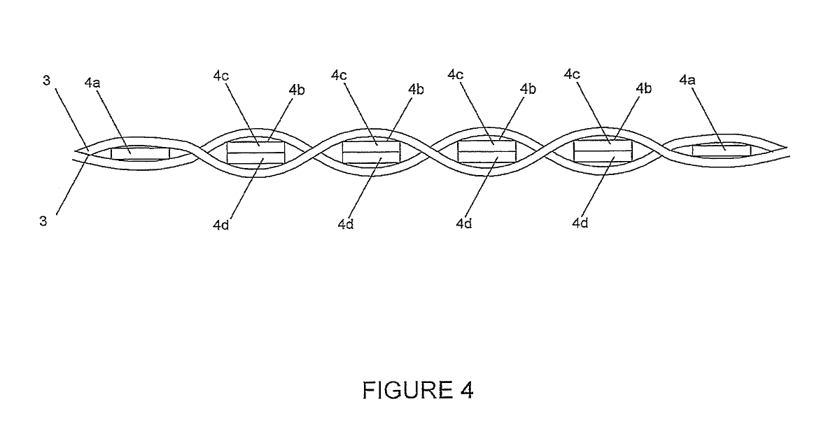

FIG. 4 is a cross-section view of a material of this embodiment woven with tapes having a rectangular cross-section (as in FIG. 3) and in which the thickness of some of the warp tapes 4b is twice the thickness of other warp tapes 4a. In the illustrated embodiment, the thicker warp tapes 4b are also thicker than the weft tapes 3. The thinner warp tapes 4a are illustrated with about the same thickness as the weft tapes, but the thinner warp tapes could have a different thickness to the weft tapes. In the illustrated embodiment, the thicker warp tapes comprise a stack of two rectangular filaments 4c, 4d, i.e. each of the filaments 4c and 4d has the same width as the width of the resulting composite warp tape 4b but each has a thickness of only ½ of the total thickness of the thick warp tape 4b. Alternatively the thicker warp tapes shown as each comprising two individual rectangular filaments stacked may instead comprise a single filament. In other embodiments, the thickness of the thicker warp tapes 4b may be more than twice the thickness of the thinner warp (or weft) tapes. The thickness of the warp tapes may be 110% to 500% that of the thinner warp (or weft) tapes.

In an alternative form the weft tapes 3 instead of the warp tapes may have such increased thickness.

Where the warp or weft tapes with greater thickness comprise multiple individual filaments, in such embodiments the warp or weft tapes with greater thickness may be composed of between 2 and 12, 4 and 8, or 2, or 3 individual filaments. Alternatively, the warp or weft tapes with greater thickness may be 110% to 500% thicker than the tapes with a lesser thickness.

Another useful characteristic to vary is the level of pigmentation. For example, a sheet material may comprise tapes all containing the same pigmentation colour, for example a white pigment. However, certain areas of the sheet may comprise tapes with lower amounts of white pigmentation, and other areas of the sheet may comprise higher levels of white pigmentation.

Being able to alter the architecture or construction of the cover we are able to create a material for specific plant cropping situations.

The foregoing describes the invention including preferred forms thereof. Alterations and modifications as will be obvious to those skilled in the art are intended to be incorporated in the scope hereof.

1. A ground cover sheet material having a greater length than width and woven from at least two different types of tapes, a first type of tape having different reflecting, absorbing or transmission properties to a second type of tape, each type of tape forming at least 5% or 10% of the surface area of the ground cover material.

2. A ground cover sheet material as claimed in claim 1, the ground cover sheet material being woven from three different types of tapes, a third type of tape having different reflecting, absorbing or transmission properties to the first and second types of tapes, each type of tape forming at least 5% or 10% of the surface area of the ground cover material.

3. A ground cover sheet material as claimed in either claim 1 or 2 wherein at least one of said types of tape reflect sufficient solar radiation in the visible (about 400-700 nm) range to enhance plant growth or fruit production of plants located proximate to said cover sheet material.

4. A ground cover sheet material as claimed in either claim 1 or 2 wherein at least one of said types of tape impacts on reflectance, absorption or transmittance of solar radiation to enhance plant growth or fruit production of plants located proximate to said cover sheet material by increasing soil temperature when compared to a black tape.

5. A ground cover sheet material as claimed in any one of claims 1 to 4 wherein the first type of tape comprises a first pigment system and the second type of tape comprises a second pigment system or is unpigmented.

6. A ground cover as claimed in claim 5 wherein the first pigment system comprises a first white pigment and the second pigment system comprises a second white pigment.

7. A ground cover sheet material as claimed in claim 5 wherein the first pigment system comprises a pigment so that the first tape is coloured one of white, black, grey, green, red, brown, tan and blue, and the second pigment system comprises a pigment so that the second tape is coloured a different one of white, black, grey, green, red, brown, tan and blue.

8. A ground cover sheet material as claimed in claim 7 wherein the first pigment system comprises a white pigment and the second pigment system comprises a black pigment.

9. A ground cover sheet material as claimed in claim 8 wherein the black pigment is an organic black pigment.

10. A ground cover sheet material as claimed in claim 9 wherein the black pigment is carbon black.

11. A ground cover sheet material as claimed in any one of claims 8 to 10 wherein the white pigment is a UV reflecting white pigment.

12. A ground cover sheet material as claimed in any one of claims 8 to 10 wherein the white pigment is a UV absorbing white pigment.

13. A ground cover sheet material as claimed in claim 12 wherein the white pigment is a UV absorbing and high IR reflecting white pigment.

14. A ground cover sheet material according to claim 8, wherein said white pigment is a main pigment and the first type of tape comprises at least one co-pigment, the co-pigment or pigments comprising titanium dioxide or another UV absorbing substance in an amount that decreases the reflectance at 280 nm 400 nm due to the main pigment by increasing UV absorbance.

15. A ground cover as claimed in claim 14 wherein the first type of tape absorbs more solar radiation than it reflects in the UV (about 280-400 nm) range, and which reflects more solar radiation than it either transmits or absorbs in the visible (about 400-700 nm) and near infrared (about 700-800 nm) ranges, and which transmits at least part of solar radiation in the range about 800-2500 nm and at least part of solar radiation above about 2500 nm.

16. A ground cover as claimed in claim 14 wherein the reflectance and transmittance of the first type of tape is shown in the table below:

| Wavelength nm | Reflectance | Transmittance |
|---|---|---|
| 280-420 | 0 to 15% | 0 to 15% |
| 421-700 | 40-95% | 5-50% |

17. A ground cover sheet material as claimed in claim 15 wherein the first type of tape comprises an organic UV absorbing substance as a co-pigment.

18. A ground cover sheet material as claimed in claim 14 wherein first type of tape comprises an inorganic UV absorbing substance as a co-pigment.

19. A ground cover sheet material as claimed in claim 18 wherein the inorganic UV absorbing substance is chosen from the group consisting of barium titanate, magnesium titanate, strontium titanate, neodymium titanate, tin oxide, titanium oxide, titanium dioxide, silica, alumina, zinc oxide, zinc sulphide, zinc sulphate, zirconium silicate and magnesium oxide.

20. A ground cover sheet material as claimed in claim 34 wherein the inorganic UV absorbing substance is added at a rate of 0.1% to 5% by weight.

21. A material as claimed in claim 7 wherein the green is Pantone green 627U, or has CIELAB coordinates L*, a*, b* of about 32, −6.6 and 4.1.

22. A material as claimed in claim 7 wherein the tan is Pantone tan 7502U or has CIELAB coordinates L*, a*, b* of about 66, 6.6 and 18.3.

23. A material as claimed in claim 7 wherein the grey is Pantone grey 426U.

24. A material as claimed in claim 7 wherein the grey is a colour with CIELAB coordinates L*, a*, b* of about 49, 0.2 and 3.3.

25. A material as claimed in claim 7 wherein the grey is a colour with CIELAB coordinates L*, a*, b* of about 40, −0.5 and −3.4.

26. A ground cover sheet material as claimed in claim 2 wherein the first type of tape comprises a first pigment system, the second type of tape comprises a second pigment system and the third type of tape comprises a third pigment system or is unpigmented.

27. A ground cover sheet material as claimed in claim 26 wherein
the first pigment system comprises a pigment so that the first tape is coloured one of white, black, green, red, brown, aluminium or blue, and
the second pigment system comprises a pigment so that the second tape is coloured a different one of white, black, green, red, brown and blue to the colour of the first tape, and
the third pigment system comprises a pigment so that the third tape is coloured a different one of white, black, green, red, brown and blue to the colours of the first and second tapes.

28. A ground cover sheet material as claimed in claim 27 wherein the first type of tape is white comprising a white pigment, the second type of tape is black comprising a black pigment, and the third type of tape is green comprising a green pigment.

29. A ground cover sheet material as claimed in claim 27 wherein the first type of tape is black comprising a black pigment, the second type of tape is green comprising a green pigment, and the third type of tape comprises an metallic pigment

30. A ground cover sheet material as claimed in claim 29 wherein the metallic pigment is an aluminium pigment.

31. A ground cover sheet material as claimed in claim 26 wherein the first type of tape is a first colour, the second type of tape is a second colour, and the third type of tape is a third colour.

32. A material as claimed in claim 31 wherein the first colour is green and the second colour is brown.

33. A material as claimed in claim 31 wherein the first colour is green and the second colour is tan.

34. A material as claimed in claim 33 wherein the first colour is Pantone green 627U and the second colour is Pantone tan 7502U.

35. A material as claimed in claim 33 wherein the green has CIELAS coordinates L*, a*, b* of about 32, −6.6 and 4.1, and the tan has CIELAB coordinates L*, a*, b* of about 66, 6.6 and 18.3.

36. A material as claimed in claim 35 wherein the third colour has CIELAB colour space coordinates L*, a*, b* of about 50, −1.5 and 16.8.

37. A material as claimed in claim 35 or 36 wherein yarns or tapes of the third colour comprise a blend of 10 to 30% of a masterbatch of the first colour and 70 to 90% of a masterbatch of the second colour.

38. A material as claimed in claim 37 wherein yarns or tapes of the third colour comprise a blend of 20% of a masterbatch of the first colour and 80% of a masterbatch of the second colour.

39. A material as claimed in claim 31 wherein the first colour is green and the second colour is grey.

40. A material as claimed in claim 39 wherein the first colour is Pantone green 627U and the second colour is Pantone grey 426U.

41. A material as claimed in claim 39 wherein the green is a colour with CIELAB colour space coordinates L*, a*, b* of about 32, −6.6 and 4.1, and the grey a colour with CIELAB colour space coordinates L*, a*, b* of about 49, 0.2, 3.3.

42. A material as claimed in claim 41 wherein the third colour with CIELAB colour space coordinates L*, a*, b* of about 41, −2 and 3.7.

43. A material as claimed in claim 39 wherein the first colour is Pantone green 627U and the second colour is a colour with CIELAB coordinates L*, a*, b* of about 49, 0.2 and 3.3.

44. A material as claimed in claims 39 to 43 wherein yarns or tapes of the third colour comprise a blend of 10 to 30% of a masterbatch of the first colour and 70 to 90% of a masterbatch of the second colour.

45. A material as claimed in claim 44 wherein the third colour is a blend of 80% of the first colour and 20% of the second colour.

46. A material as claimed in claim 31 wherein the first colour is tan and the second colour is grey.

47. A material as claimed in claim 46 wherein the first colour is Pantone tan 7502U and the second colour is a colour with CIELAB coordinates L*, a*, b* of about 49, 0.2 and 3.3.

48. A material as claimed in claim 46 wherein the tan is a colour with CIELAB colour space coordinates L*, a*, b* of about 66, 6.2 and 18.3 and the grey is a colour with CIELAB colour space coordinates L*, a*, b* of about 49, 0.2, 3.3.

49. A material as claimed in claim 48 wherein the third colour is a colour with CIELAB colour space coordinates L*, a*, b* of about 55, 3 and 12.

50. A material as claimed in claim 46 wherein the first colour is colour is Pentane tan 7502U and the second colour is a colour with CIELAB coordinates L*, a*, b* of about 40, −0.5 and −3.4.

51. A material as claimed in claim 46 wherein the tan is a colour with CIELAB colour space coordinates L*, a*, b* of about 66, 6.2 and 18.3 and the grey is a colour with CIELAB colour space coordinates L*, a*, b* of about 40, −0.5 and −3.4.

52. A material as claimed in claim 51 wherein the third colour is a colour with CIELAB colour space coordinates L*, a*, b* of about 49, 0.2 and 3.3.

53. A material as claimed in claims 46 to 51 wherein the third colour is a blend of 70 to 90% of the first colour and 10 to 20% of the second colour.

54. A material as claimed in claim 53 wherein the third colour is a blend of 80% of the first colour and 20% of the second colour.

55. A ground cover sheet material as claimed in any one of the proceeding claims wherein the first type of tape comprises pigment at a first pigment level and the second type of tape comprises the pigment at a second pigment, level.

56. A ground cover sheet material as claimed in claim 55 wherein the pigment is a black pigment and the first pigment level is 1.5% to 2.5% by weight and the second pigment level is 0.5% to 1.5% by weight.

57. A ground cover sheet material as claimed in claim 55 wherein the pigment is a white pigment and the first pigment level is 1% to 5% by weight and the second pigment level is 0.1% to 1.0% by weight.

58. A ground cover sheet material as claimed in claim 55 wherein the pigment is a UV reflecting white pigment and the first pigmentation level is 15% to 30% by weight and the second pigmentation level is 5% to 15% by weight.

59. A ground cover sheet material as claimed in any one of the preceding claims wherein the first type of tape comprises a first thickness and the second type of tape comprises a second thickness, the first thickness being greater than the second thickness.

60. A ground cover sheet material as claimed in claim 59 wherein the first thickness is at least 20% more than the second thickness.

61. A ground cover material as claimed in claim 59 wherein the first thickness is at least 50% more than the second thickness.

62. A ground cover material as claimed in claim 59 wherein the first thickness is at least 1.2 to 5 times the second thickness.

63. A ground cover sheet material according to any one of claims 59 to 62 wherein the thickest tapes comprise multiple individual tapes stacked together.

64. A ground cover sheet material as claimed in claim 59 wherein the first type of tape comprises a white pigment and the first thickness, and the second type of tape comprises a black pigment and the second thickness, and the first thickness is greater than the second thickness.

65. A ground cover sheet material as claimed in any one of claims 1 to 64, wherein the ground cover sheet material comprises warp and weft tapes, and some of the warp tapes are formed from one of the first type of tape and the second type of tape, and other warp tapes are formed from the other one of the first type of tape and the second type of tape.

66. A ground cover sheet material as claimed in any one of claims 1 to 65, wherein the ground cover sheet material comprises warp and weft tapes, and at least some of the warp tapes are formed from one of the first type of tape and the second type of tape, and at least some of the weft tapes are formed from the other one of the first type of tape and the second type of tape.

67. A ground cover sheet material as claimed in claim 66, wherein at least some of the warp tapes are formed from one of the first type of tape and the second type of tape and substantially all of the weft tapes are formed from the other one of the first type of tape and the second type of tape.

68. A ground cover sheet material as claimed in claim 66, wherein substantially all of the warp tapes are formed from one of the first type of tape and the second type of tape and at least some of the weft tapes are formed from the other one of the first type of tape and the second type of tape.

69. A ground cover material as claimed in claim 66 wherein substantially all of the warp tapes are formed from one of the first type of tape and the second type of tape and substantially all of the weft tapes are formed from the other one of the first type of tape and the second type of tape.

70. A ground cover sheet material as claimed in claim 66 wherein a majority of the warp tapes comprise one of the first type of tape and the second type of tape, and a majority of the weft tapes comprise the other one of the first type of tape and the second type of tape.

71. A ground cover sheet material as claimed in claim 65 wherein the warp tapes in a portion of the width of the sheet material are formed from one of the first type of tape and the second type of tape and the warp tapes in a remaining portion of the width of the cover material comprise the other one of the first type of tape and the second type of tape.

72. A ground cover sheet material as claimed in claim 71 wherein the portion is a central portion of the width of the sheet material.

73. A ground sheet material as claimed in claim 71 wherein the portion is a side portion adjacent a longitudinal side of the ground cover sheet material.

74. A ground cover sheet material as claimed in claim 71 wherein the portion comprises at least 10% or 20% or 30% or 40% or 50% or 60% or 70% or 80% of the width of the ground cover sheet material.

75. A ground cover sheet material as claimed in claim 65 wherein alternate warp tapes are formed from the first and second types of tape.

76. A ground cover sheet material as claimed in claim 65 wherein the warp tapes are formed into groups of warp tapes formed from the first type of tape and spaced apart across the width of the ground cover sheet material by groups of warp tapes formed from the second type of tape.

77. A ground cover sheet material as claimed in claim 74 wherein each group of warp tapes formed from the first type of tape cover at least 10% of the width of the ground cover sheet material and each group of warp tapes formed from the second type of tape cover at least 10% of the width of the ground cover sheet material.

78. A ground cover sheet material as claimed in claim 65 comprising a third type of tape, wherein some warp tapes are formed from the third type of tape.

79. A ground cover sheet material as claimed in claim 78 wherein alternate warp tapes in a portion of the width of the material are formed from the first and second types of tape, and warp tapes in a remaining portion of the width of the material comprise the third type of tape.

80. A ground cover material as claimed in claim 79 wherein the portion is a longitudinal central portion of the ground cover sheet material, the remaining width of the cover material being side portions of the cover material.

81. A ground cover material as claimed in claim 79 wherein the portion is a longitudinal side portion or longitudinal side portions located on either side of a central longitudinal portion, the central portion being the remaining width of the material.

82. A ground cover material as claimed in any one of claims 78 to 81 wherein substantially all of the weft tapes comprise one of the first type of tape, the second type of tape and the third type of tape.

83. A ground cover sheet material as claimed in claim 65 comprising a third type of tape, wherein some weft tapes are formed from the third type of tape.

84. A ground cover sheet material as claimed in claim 7 wherein the first or second type of tape is coloured green and comprises:
a polymer and a green pigment derived from one or more pigments mixed to form a polymer-pigment mixture with solar radiation reflecting and absorbing or transmittance properties, and
at least one additional pigment added to the polymer-pigment mixture which does not significantly decrease the amount of solar radiation transmitted by the polymer-pigment mixture in the range of about 700 nm 2500 nm, and/or
at least one additional pigment added to the polymer-pigment mixture which decreases the amount of solar radiation transmitted by the material in the blue light range of about 440 nm 490 nm) and in the red light range of about 620-700 nm.

85. A material as claimed in claim 84 wherein the at least one additional pigment added to the polymer-pigment mixture increases the amount of solar radiation transmitted by the polymer-pigment mixture in the range of about 700 nm-2500 nm.

86. A material as claimed in claim 84 wherein the at least one additional pigment increases or at least does not decrease the amount of solar radiation transmitted by the material in the range of about 700 nm-800 nm.

87. A material as claimed in claim 84 wherein the at least one additional pigment increases, or at least does not increase, the amount of solar radiation transmitted by the material in the range of about 700 nm-760 nm

88. A material as claimed in any one of claims 84 to 87 wherein the material transmits more solar radiation than it reflects in the range of about 700 nm-2500 nm.

89. A material as claimed in any one of claims 84 to 88 wherein the material is substantially transparent to solar radiation in the range of about 700 nm-2500 nm.

90. A material as claimed in any one of claims 84 to 89 wherein the material absorbs at least 10%, 20%, 30%, 40%, 50%, 60%, 70%, 80%, 90% or 95% of solar radiation in the UV range of about 280-400 nm and at least 10%, 20%, 30%, 40%, 50%, 60%, 70%, 80%, 90% or 95% of solar radiation in the visible range of about 400-700 nm.

91. A material as claimed in any one of claims 84 to 90 wherein the green pigment is phthalocyanine green.

92. A material as claimed in claim 91 wherein the phthalocyanine green is provided in the amount of 0.5-5%, or 0.5-4%, or 0.5-3%, or 0.5-2%, or 0.5-1% by weight.

93. A material as claimed in any one of claims 84 to 92 wherein the material comprises iron oxide as an additional pigment.

94. A material as claimed in claim 93 wherein the iron oxide is provided in the amount of 0.2-5%, or 0.2-4%, or 0.2-3%, or 0.2-2%, or 0.2-1%, or 0.2-0.75% by weight.

95. A material as claimed in any one of claims 84 to 94 wherein the material comprises organic orange as an additional pigment.

96. A material as claimed in claim 95 wherein the organic orange pigment is benzimidazolone.

97. A material as claimed in claim 95 or 96 wherein the inorganic orange pigment is provided in the amount of 0.2-5%, or 0.2-4%, or 0.2-3%, or 0.2-2%, or 0.2-1%, or 0.2-0.4% by weight.

98. A material as claimed any one of claims 95 to 97 wherein the material comprises silica as an additional pigment.

99. A ground cover sheet material as claimed in claim 98 wherein the silica is provided in the amount of 0.2-5%, or 0.2-4%, or 0.2-3%, or 0.2-2%, or 0.2-1%, or 0.2-0.4% by weight.

100. A material as claimed in any one of claims 84 to 99 wherein the polymer comprises polyethylene or polypropylene or a mixture thereof.

101. A material as claimed in any one of claims 84 to 100 wherein the sheet material is in the form of tape comprising the polymer-pigment mixture.

102. A material as claimed in claim 101 wherein the tape has a rectangular cross-section.

103. A ground cover sheet material as claimed in claim 7 wherein the first or second type of tape is coloured green, and wherein the green tape is substantially transparent to solar radiation above about 700 nm and absorbs some solar radiation in the UV range of about 280-400 nm and some of the visible range of about 400-700 nm.

104. A material as claimed in claim 103 wherein the material has more than 10% transparency to solar radiation across the wavelength range of 700 to 800 nm and absorbs more blue light (440 to 490 nm) than green light (490 to 570 nm), and absorbs more red light (620 to 780 nm) than green light (490 nm to 570 nm).

105. A material as claimed in claim 103 or 104 wherein the average transmission across the wavelength range 900-1000 nm is at least 55, 58, 60, 62, 65 or 67 percentage points greater than the average wavelength across the 500-600 nm range.

106. A material as claimed in claim 103 wherein the material transmits more than either 15%, 20%, 25%, 30%, 35%, 40%, 45%, 50%, 60%, 70%, 80%, 90%, or 95% of solar radiation across the wavelength range 700-800 nm, or across the wavelength range 700 to 760 nm.

107. A material as claimed in either of claims 103 to 106 wherein the material transmits more than 30%, 40%, 50%, 60%, 70%, 80%, 90%, or 95% of solar radiation across the wavelength range 700 to 2100 nm.

108. A material as claimed in any one of claims 103 to 107 wherein the material absorbs more than either 20%, 30%, 40%, 50%, 60%, 70%, 80%, 90%, or 95% of the total of blue light plus red light and transmits more than either 20%, 30%, 40%, 50%, 60%, 70%, 80%, 90%, or 95% of green light.

109. A material as claimed in any of claims 103 to 108 wherein said material reflects at least 10%, 20%, 30%, 40%, 50%, 60% or 70% of green light.

110. A material as claimed in any of claims 103 to 109 wherein said material absorbs more than at least 10%, 20%, 30%, 40%, 50%, 60%, 70%, 80%, 90% or 95% of solar radiation in the UV range of about 280-400 nm.

111. A material as claimed in any of claims 103 to 110 wherein said material transmits less than either 90%, 80%, 70%, 60%, 50%, 40%, 30%, 20% or 10% of solar radiation in the UV range of about 280-400 nm.

112. A ground cover material as claimed in claim 7 wherein the first or second type of tape is coloured green, and wherein the green tape comprises:
a polymer or polymers and pigments together forming a polymer-pigment mixture, wherein the pigments comprise phthalocyanine green, iron (III) oxide and organic orange.

113. A material as claimed in claim 112 wherein the organic orange pigment is benzimidazolone.

114. A material as claimed in any one of claims 84 to 113 that is stable in colour for at least 1 year, 1.5 years, 2 years, 2.5 years, 3 years, 4 years, 5 years, 6 years, 7 years, 8 years, 9 years, 10 years, 11 years or 12 years.

115. A material as claimed in any one of claims 84 to 114 that has less than 0.5% or 0.3%, 0.1% or 0.05% by weight carbon black pigment, or contains no carbon black pigment.

116. A material as claimed in any one of claims 84 to 102 and 112 to 115, wherein the iron oxide is red iron oxide.

117. A material as claimed in any one of claim 116, wherein the iron oxide is micronized iron oxide.

118. A ground cover sheet material according to any one of the preceding claims wherein the warp tapes and the weft tapes have a rectangular or square cross-section.

119. A ground cover sheet material according to any one of the preceding claims wherein some or all of the tapes are formed from polyethylene or polypropylene or a mixture thereof.

120. A ground cover as claimed in any one of claims 14 to 20 wherein the first type of tape absorbs more solar radiation than it reflects in the UV (about 280-400 nm) range, and which reflects more solar radiation than it either transmits or absorbs in the visible (about 400-700 nm) and near infrared (about 700-800 nm) ranges; and wherein the material reflects at least about 50% of solar radiation in the infrared range of about 700-1000 nm, and/or reflects at least about 40% of solar radiation in the infrared range of about 1000-1500 nm, and/or reflects at least about 30% of solar radiation in the infrared range of about 1500-2000 nm.
